(19) United States
(12) Patent Application Publication
(10) Pub. No.: US 2025/0350971 A1
(43) Pub. Date: Nov. 13, 2025

(54) METHODS FOR SENSING IN A WIRELESS LOCAL AREA NETWORK (WLAN)

(71) Applicant: INTERDIGITAL PATENT HOLDINGS, INC., Wilmington, DE (US)

(72) Inventors: Zinan Lin, Basking Ridge, NJ (US); Mahmoud Saad, Montreal (CA); Rui Yang, Greenlawn, NY (US)

(73) Assignee: INTERDIGITAL PATENT HOLDINGS, INC., Wilmington, DE (US)

(21) Appl. No.: 18/860,076

(22) PCT Filed: Apr. 26, 2023
(86) PCT No.: PCT/US2023/020024

§ 371 Date: Oct. 25, 2024

Related U.S. Application Data
(60) Provisional application No. 63/335,061, filed on Apr. 26, 2022.
(60) Provisional application No. 63/355,455, filed on Jun. 24, 2022.

(51) Int. Cl. H04W 24/08; H04W 84/12

(52) U.S. Cl. CPC H04W 24/08; H04W 84/12

(57) ABSTRACT

Methods for wireless local area network (WLAN) sensing are provided herein. A method performed by a sensing responder may include receiving a first sensing measurement setup request message indicating a first one or more parameters to be used in a sensing measurement procedure. The method may include transmitting a first sensing measurement setup response message indicating at least one parameter that differs from the first one or more parameters indicated by the sensing measurement setup request message. The method may include receiving a second sensing measurement setup request message indicating a second one or more parameters to be used in the sensing measurement procedure. The second one or more parameters to be used in the sensing measurement procedure may include at least one parameter that differs from the first one or more parameters indicated by the first sensing measurement setup request message.

### CROSS-REFERENCE TO RELATED APPLICATIONS

This application claims the benefit of U.S. Provisional Application No. 63/335,061, filed Apr. 26, 2022 and U.S. Provisional Application No. 63/355,445 filed Jun. 24, 2022, the contents of which are incorporated herein by reference BACKGROUND

Wireless Local Area Network (WLAN) sensing may enable a station (STA) to obtain sensing measurements of the channel(s) between two or more STAs and/or the channel between a receive antenna and a transmit antenna of a STA. With the execution of a WLAN sensing procedure, it is possible for a STA to obtain sensing measurements useful for detecting and tracking changes in the environment.

### SUMMARY

Methods for wireless local area network (WLAN) sensing are provided herein. A method performed by a sensing responder may include receiving a first sensing measurement setup request message indicating a first one or more parameters to be used in a sensing measurement procedure. The method may include transmitting a first sensing measurement setup response message indicating at least one parameter that differs from the first one or more parameters indicated by the sensing measurement setup request message. The method may include receiving a second sensing measurement setup request message indicating a second one or more parameters to be used in the sensing measurement procedure. The second one or more parameters to be used in the sensing measurement procedure may include at least one parameter that differs from the first one or more parameters indicated by the first sensing measurement setup request message.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an illustration including multiple examples of trigger-based (TB) sensing measurement procedures that may use one of several different types of sounding;

FIG. 3 depicts different examples of a trigger-based measurement procedure;

FIG. 4 illustrates an example format of the Sensing Measurement Setup Request frame;

FIG. 5 illustrates an example format of a Sensing Measurement Setup Response frame;

FIG. 6 illustrates an example format of the Sensing Measurement Parameters element;

FIG. 7 illustrates an example of the Sensing Measurement Parameters field as may be included in an action frame or element such as the Sensing Measurement Parameters element illustrated in FIG. 6;

FIG. 8 illustrates an example format of the Sensing Measurement Setup Termination frame;

FIG. 9 illustrates an example format of the SBP Request frame;

FIG. 10 illustrates an example format of the SBP Response frame;

FIG. 11 illustrates an example of a Trigger Frame format;

FIG. 12 illustrates an example format of an extremely high throughput (EHT) Variant User Info field;

FIG. 13 illustrates an example format of an EHT Special User Info field;

FIG. 14 is a table illustrating example encodings of the Trigger Type subfield included in the Common Info subfield of a Trigger Frame;

FIG. 15 illustrates an example format of the Trigger Dependent Common Info subfield of a Ranging Trigger frame;

FIG. 16 is a table illustrating an example encoding of the Trigger Dependent Common Info subfield for the Ranging Trigger Frame variant

FIG. 17 illustrates another example format of the Trigger Dependent Common Info subfield of a Ranging Trigger frame;

FIG. 18 illustrates an example format of the Trigger Dependent User Info field in a Ranging Trigger frame as may be included for Poll and Report subvariant frames;

FIG. 19 and FIG. 20 illustrate example formats of the Trigger Dependent User Info field in the Sounding and Secured Sounding subvariants of a Ranging Trigger frame, respectively;

FIG. 21 illustrates an example encoding of a NDP Announcement variant frame;

FIG. 22 illustrates an example of an NDPA Announcement frame format;

FIG. 23 illustrates an example of the STA Info field of the EHT NDPA variant;

FIG. 24 illustrates an example format of the Special STA Info field when the AID11 subfield has a value of less than 2008;

FIG. 25 illustrates an example format of the Special STA Info field when the AID11 subfield has a value of 2043;

FIG. 26 illustrates an example format of the Special STA Info field when the AID11 subfield has a value of 2044;

FIG. 27 illustrates an example format of the Special STA Info field when the AID11 subfield has a value of 2045;

FIG. 28 illustrates an example format of the EHT Operation element;

FIG. 29 illustrates an example format of the EHT Operation Information field;

FIG. 30 illustrates an example WLAN sensing procedure for TB measurement setup negotiation;

FIG. 31, illustrates an exemplary WLAN sensing procedure for TB measurement setup negotiation in which an alternate response is received from the sensing responder;

FIG. 32 illustrates another example WLAN sensing procedure for TB measurement setup negotiation;

FIG. 32 depicts an exemplary sensing procedure for TB measurement setup negotiation between one sensing initiator and multiple sensing responders where multiple responders have different responses indicated in Measurement Setup Request frame;

FIG. 33 illustrates an example sensing procedure for TB measurement setup negotiation between a sensing initiator and multiple sensing responders in which all of the responders accept the sensing measurement parameters indicated in a Measurement Setup Request frame;

FIG. 34 illustrates an example sensing procedure for the TB measurement setup negotiation carried out between one sensing initiator and multiple sensing responders, in which all of the responders reject the sensing measurement parameters indicated in Measurement Setup Request frame;

FIG. 35 illustrates an example of a non-TB measurement setup negotiation procedure carried out between the sensing initiator (non-AP STA) and the sensing responder (AP);

FIG. 36 illustrates an example of a non-TB measurement setup negotiation procedure involving a sensing initiator (e.g., a non-AP STA) and a sensing responder (e.g., an AP);

FIG. 37 is an illustration of an exemplary non-TB measurement setup negotiation procedure involving a sensing initiator (e.g., a non-AP STA) and the sensing responder (e.g., an AP);

FIG. 38 is another illustration of an exemplary non-TB measurement setup negotiation procedure involving a sensing initiator (e.g., a non-AP STA) and the sensing responder (e.g., an AP);

FIG. 39 is a table illustrating an exemplary encoding for a Status Code subfield in the Sensing Measurement Setup Response frame;

FIG. 40 illustrates a non-TB measurement instance in which an initiator (e.g., a Non-AP STA0) is the sensing transmitter and AP and other non-AP STAs (e.g., Non-AP STA1, non-AP STA2) are sensing receivers

FIG. 41 illustrates a non-TB measurement instance in which the initiator, e.g., Non-AP STA0, and other non-AP STAs are sensing receivers and a sensing responder (i.e., an AP) is the sensing transmitter;

FIG. 42 illustrates an example of a non-TB measurement instance in which a sensing initiator, e.g., Non-AP STAG and other non-AP STAs are sensing transmitters and an AP is a sensing receiver;

FIG. 43 illustrates an exemplary frame exchange between a non-AP STA initiating multiple simultaneous non-TB sensing measurement instances with different APs in a Multi-AP group;

FIG. 44 illustrates an exemplary SBP procedure involving multiple SBP initiators. In the example shown in FIG. 44, an SBP initiator 4420 (i.e., non-AP STA0) may first send an SBP request to the SBP responder 4410 (i.e., an AP);

FIG. 45 illustrates an exemplary SBP procedure involving a single SBP initiator and a group of SBP participants The group of SBP participants multiple SBP participants);

FIG. 46 illustrates an example of a procedure for sensing measurement termination initiated by an AP, where the AP may be the sensing initiator;

FIG. 47 illustrates an example of the exemplary Measurement Setup ID Information subfield in the Sensing Measurement Setup Termination frame Action field;

FIG. 48 illustrates an exemplary sensing measurement setup termination procedure initiated by a non-AP STA; and

FIG. 49 illustrates timing requirements for each phase of the sensing TB measurement instance.

### DETAILED DESCRIPTION

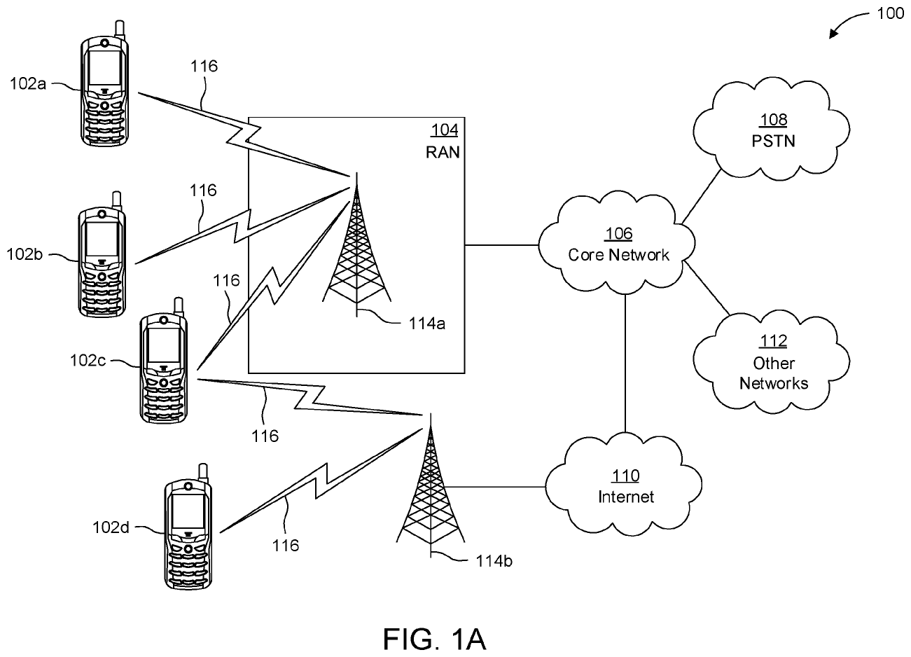

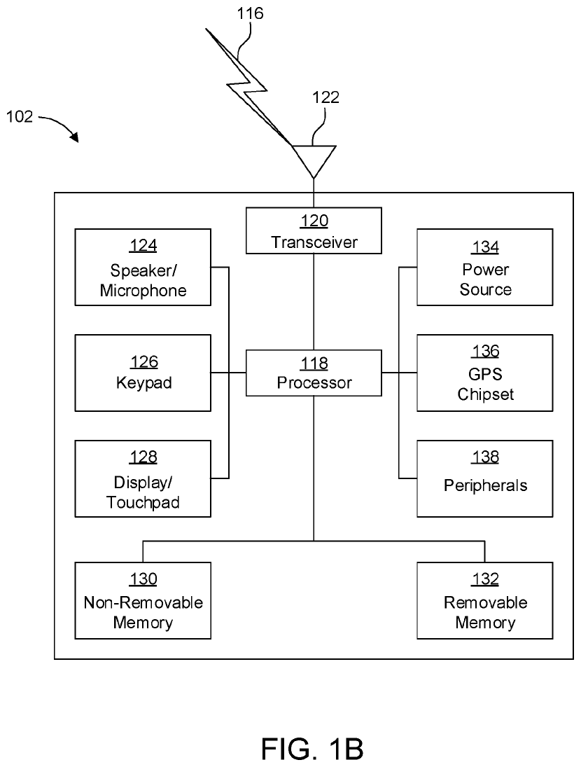

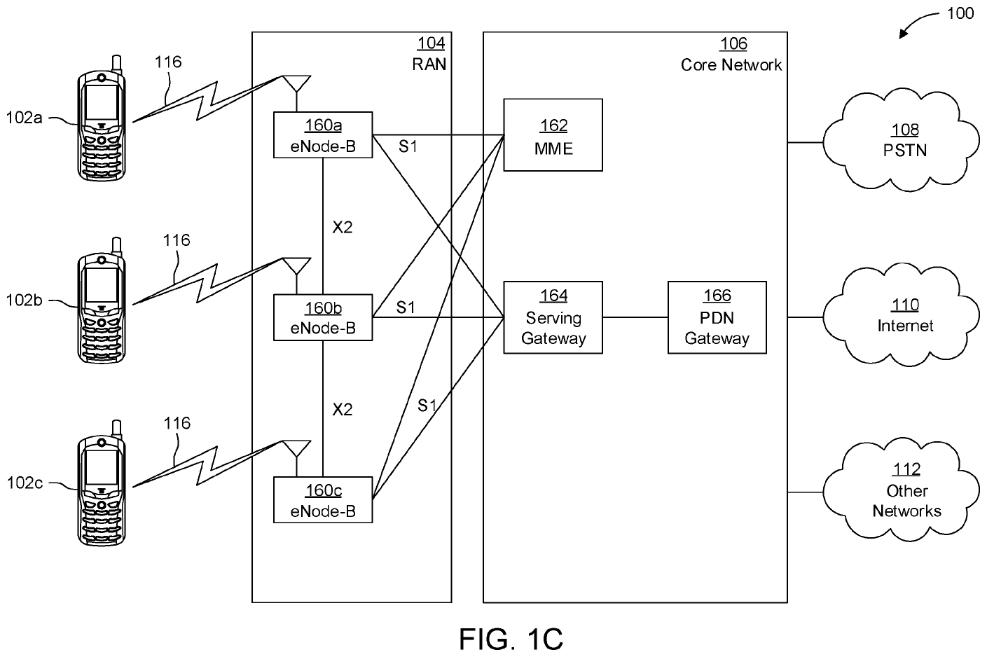

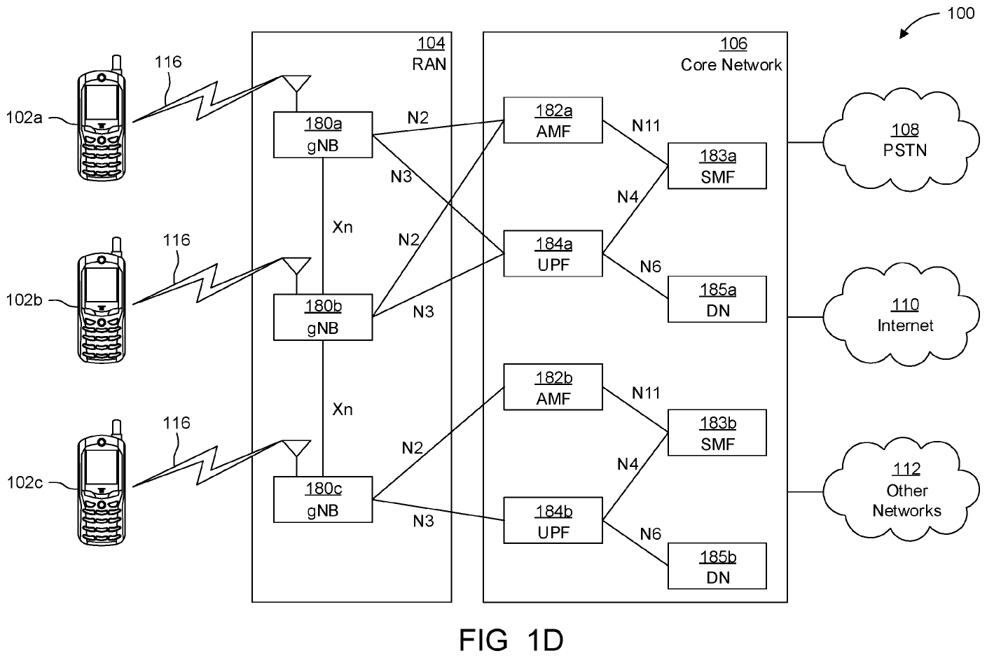

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

An overview of WLAN systems is described herein. A WLAN in Infrastructure Basic Service Set (BSS) mode may include an Access Point (AP) for the BSS and one or more stations (STAs), which may include non-AP-STAs and/or AP-STAs. One or more STAs may be associated with the AP. The AP may have access or interface to a Distribution System (DS) or another type of wired/wireless network that carries traffic in and out of the BSS. Traffic to STAs that originates from outside the BSS may arrive through the AP and be delivered to the STAs. Traffic originating from STAs to destinations outside the BSS may be sent to the AP to be delivered to the respective destinations. Traffic between STAs within the BSS may also be sent through the AP. For example, the source STA may send traffic to the AP and the AP may deliver the traffic to one or more destination STAs.

Using, for example, an 802.11ac infrastructure mode of operation, the AP may transmit a beacon using a fixed channel, which may be referred to as a primary channel. The primary channel may be 20 MHz wide, and may be considered the operating channel of the BSS. The primary channel may also be used by STAs to establish a connection with one or more APs. A fundamental channel access mechanism in an 802.11 system is Carrier Sense Multiple Access with Collision Avoidance (CSMA/CA). In this mode of operation, every STA, including the AP, may sense the primary channel. If the channel is detected to be busy, the STA may back off. Hence one STA may transmit at any given time in a given BSS.

In operation modes consistent with 802.11n, for example, High Throughput (HT) STAs may also use a 40 MHz wide channel for communication. This may be achieved by combining the primary 20 MHz channel with an adjacent 20 MHz channel to form a 40 MHz wide contiguous channel.

In operation modes consistent with 802.11ac, for example, Very High Throughput (VHT) STAs may support 20 MHz, 40 MHz, 80 MHz, and 160 MHz wide channels. The 40 MHz, and 80 MHz, channels may be formed by combining contiguous 20 MHz channels similar to 802.11n described above. A 160 MHz channel may be formed, for example, by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time-domain processing is done on each stream separately. The streams are then mapped onto the two channels, and the data may be transmitted. At the receiver, this mechanism may be reversed, and the combined data may be sent to the MAC.

To improve spectral efficiency, operation modes consistent with 802.11ac, for example, may support downlink Multi-User MIMO (MU-MIMO) transmission to multiple STAs within the time frame of the same symbol, e.g., during a downlink OFDM symbol. The potential for the use of downlink MU-MIMO may also be considered for 802.11ah operating modes. It is important to note that since downlink MU-MIMO, as it may be used in 802.11ac and other standards, may use the same symbol timing to multiple STAs interference of the waveform transmissions to multiple STA's is not an issue. However, STAs involved in MU-MIMO transmission with the AP may need to use the same channel or band, and this may limit the operating bandwidth to the smallest channel bandwidth that is supported by the STAs that are involved in the MU-MIMO transmission with the AP.

An overview of Extremely High Throughput implementation and 802.11be is provided herein. The IEEE 802.11 Extremely High Throughput (EHT) Study Group was formed in September 2018. EHT may be considered a major revision to IEEE 802.11 standards following 802.11ax. EHT may explore the possibility of further increasing peak throughput and improve efficiency of the IEEE 802.11 networks. Following the EHT Study Group, the 802.11be Task Group was established to provide for 802.11 EHT specifications. Use cases and applications addressed may include high throughput and low latency applications such as: Video-over-WLAN, Augmented Reality (AR), and Virtual Reality (VR).

A list of features that has been discussed in relation to EHT and 802.11be to achieve the target of increased peak throughput and improved efficiency at least include: Multi-AP Coordination, Multi-Band/multi-link, 320 MHz bandwidth, 16 Spatial Streams, HARQ, and new designs for 6 GHz channel access.

An introduction to 802.11bf is provided herein. The IEEE 802.11bf standard is considered an amendment to IEEE 802.11 for wireless sensing capability in WLAN. A new task group, TGbf, is tasked with generating the specification document. One or more of the following principles may be reflected in the standard. A sensing procedure may allow a STA to perform WLAN sensing and obtain measurement results. A sensing session may be considered an instance of a sensing procedure with associated operational parameters of that instance. A sensing initiator may be a STA that initiates a WLAN sensing session. A sensing responder may be a STA that participates in a WLAN sensing session initiated by a sensing initiator. A sensing transmitter may be a STA that transmits PPDUs used for sensing measurements in a sensing session. A sensing receiver may be a STA that receives PPDUs sent by a sensing transmitter and performs sensing measurements in a sensing session. A STA may assume multiple roles in one sensing session. In a sensing session, a sensing initiator may be a sensing transmitter, a sensing receiver, both or neither.

WLAN sensing is described in further detail herein. WLAN sensing may enable a STA (e.g., a non-AP STA or an AP-STA) to obtain sensing measurements of the channel(s) used for communication between two or more STAs and/or the channel between a receive antenna and a transmit antenna of a STA. With the execution of the WLAN sensing procedure, it is possible for a STA to obtain sensing measurements useful for detecting and tracking changes in the environment.

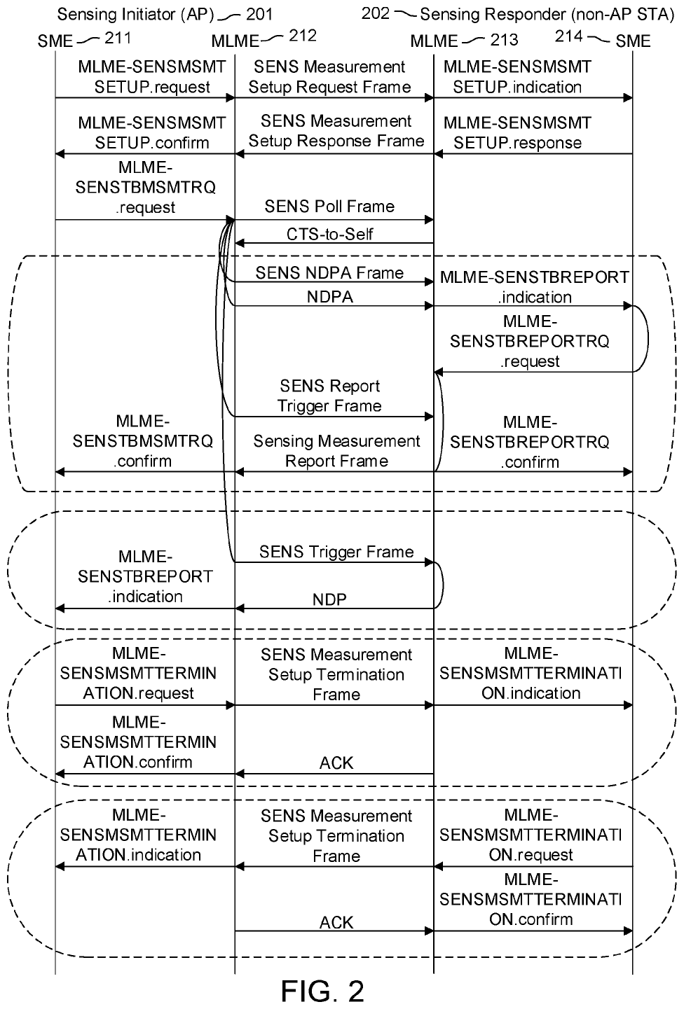

FIG. 2 is an illustration including multiple examples of trigger-based (TB) sensing measurement procedures that may use one of several different types of sounding. As shown in FIG. 2, TB sensing measurement sensing procedures may involve at least one sensing initiator (e.g., an AP 210) and at least one sensing responder (e.g., a non-AP STA 220). The illustration shown in FIG. 2 may portray signaling exchanges both between the initiator 210 and the responder 220 at the medium access control (MAC) layer or physical (PHY) layer and between higher layer entities implemented within the initiator 210 and the responder 220. As shown in FIG. 2, the sensing initiator 210 has a station management entity 211 and a MAC layer management entity (MLME) 212. Similarly, the sensing responder 220 has an MLME 221 and an SME 222. The SMEs 211 and 222 are responsible for generating primitives from which MLMEs 212 and 221 construct frames (e.g., SENS measurement setup request frames, SENS measurement setup response frames, etc.).

As shown in FIG. 2, upon generation of the MLME-SESTBMSMTRQ.request primitive, by the SME 211, the sensing initiator 201 may be configured to initiate Null data packet announcement (NDPA) sounding and/or trigger frame (TF) sounding. Upon generation of the MLME-SENSMSMTTERMINATION.request primitives, by the SME 211 or by the SME 213, the sensing initiator 201 and/or the sensing responder 202 may be configured to terminate sensing measurement setup. NDPA and TF sounding procedures, as well as the sensing measurement setup termination procedures and are described in further detail in paragraphs below. It should be understood that the illustration of FIG. 2 is an example of the basic procedure and is not an exhaustive illustration of all possible uses of the protocol.

The format of a Sensing Measurement Setup Request frame is described herein. The Sensing Measurement Setup Request frame may be transmitted, for example, by a sensing initiator to request sensing measurement setup.

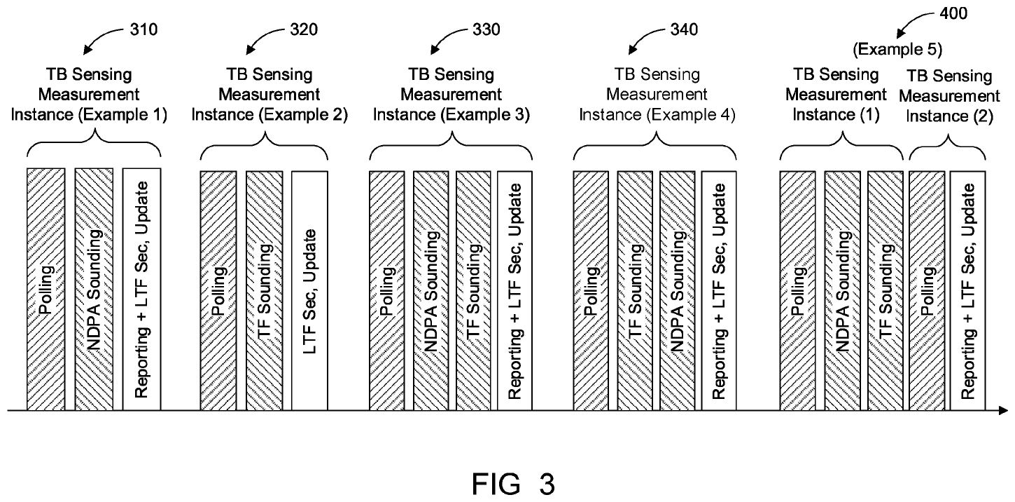

FIG. 3 depicts different examples of a trigger-based measurement procedure. As shown in each of the examples 310, 320, 330, 340, and 350, a trigger-based measurement instance may be initiated by a polling phase (which may including the transmission or reception of one or more polling frames). As shown in example 310 the polling phase is followed a short interframe spacing (SIFS) after by an NDPA Sounding phase. As is further illustrated in example 310, the sounding phase may be followed a SIFS after by a Reporting phase. Example 320 is similar to example 310, at least one difference being that the NDPA Sounding phase is replaced by a TF Sounding phase. As shown in examples 330 and 340, a measurement instance may include both NDPA Sounding phase and TF Sounding phases, and such phases may be carried out in different orders. As shown in example 350, two measurement instances may be carried out. In the scenario depicted, the Reporting phase may be delayed and may be carried out in another TB measurement instance.

In the following paragraphs, details as to the format of a Sensing Measurement Setup Request frame are provided. The Sensing Measurement Setup Response frame may be transmitted by a sensing responder, for example, in response to a Sensing Measurement Setup Request frame.

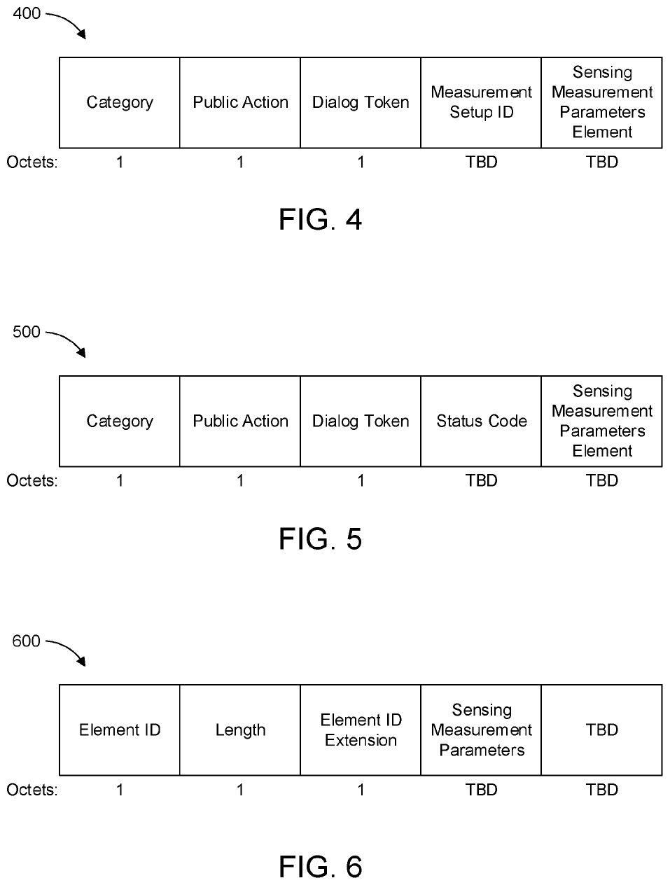

FIG. 4 illustrates an example format of the Sensing Measurement Setup Request frame. The format of the Sensing Measurement Setup Request frame may define fields of an Action frame. As shown in FIG. 4, the Sensing Measurement Setup Request frame 400 may include a Measurement Setup ID field and/or a Sensing Measurement Parameters Element. The Measurement Setup ID field may include information indicating a Measurement Setup ID that identifies assigned parameters in the Sensing Measurement Parameters Element to be used in the corresponding sensing measurement instances. The Sensing Measurement Parameters Element may be further defined, for example, in subsequent paragraphs herein.

FIG. 5 illustrates an example format of a Sensing Measurement Setup Response frame. The format of the Sensing Measurement Setup Response frame may define fields of an Action frame. As shown in FIG. 5, the Sensing Measurement Setup Response frame 500 may include a Status Code field and/or a Sensing Measurement Parameters Element. The Status Code field may indicate a response to one or more parameters, fields, or elements included, for example, in a Sensing Measurement Setup Request frame. For instance, the value indicated by the Status Code field may indicate that that the request is successful, that the request is declined, and/or that the request is rejected. The Sensing Measurement Parameters Element may be present in the Sensing Measurement Setup Response frame depending on the value of the Status Code. For example, the Sensing Measurement Parameters Element present in the Sensing Measurement Setup Response frame may include one or more suggested parameters to be used in a sensing procedure (e.g., PREFERRED_MEASURMENT_SETUP_PARAMETERS_SUGGESTED). In some cases, the Sensing Measurement Parameters Element may not be present in the Sensing Measurement Setup Response frame. The Sensing Measurement Parameters Element may be further defined in subsequent paragraphs herein.

The Sensing Measurement Parameters Element is described in greater detail herein. The Sensing Measurement Parameters Element may include information indicating operational attributes of the corresponding sensing measurement instance.

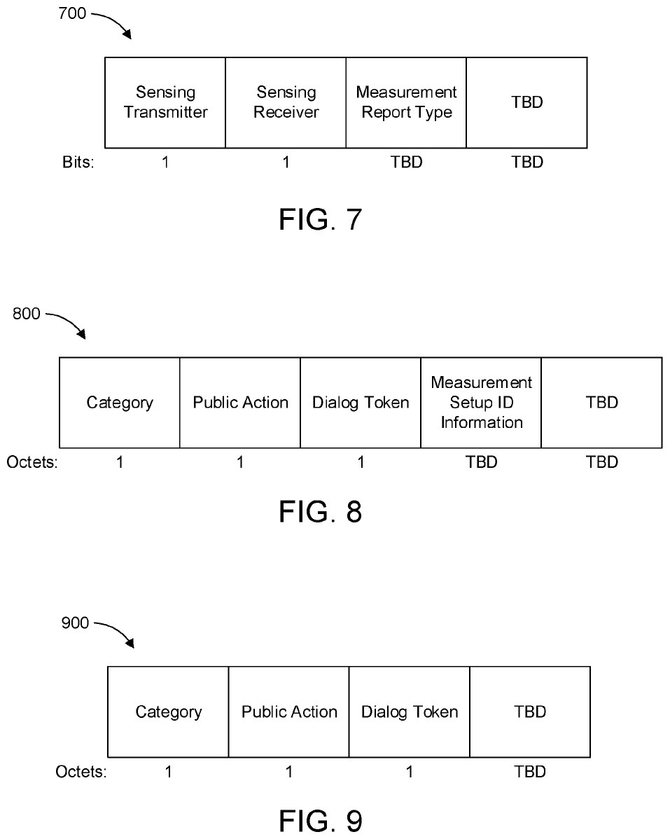

FIG. 6 illustrates an example format of the Sensing Measurement Parameters element. As shown in FIG. 6, the Sensing Measurement Parameters element 600 may include an Element ID field, a Length field, and/or a Sensing Measurement Parameters field. The Sensing Measurement Parameters Field is further detailed with respect to FIG. 7, described below.

FIG. 7 illustrates an example of the Sensing Measurement Parameters field as may be included in an action frame or element such as the Sensing Measurement Parameters element illustrated in FIG. 6 and described above. As shown in FIG. 7, the Sensing Measurement Parameters field 700 may include, e.g., a Sensing Transmitter subfield, a Sensing Receiver subfield, a Measurement Report Type subfield, and/or one or more other subfields. The Sensing Transmitter and Sensing Receive subfields may respectively indicate one or more identifiers of STA(s) to which the role(s) of sensing transmitter(s) and sensing receiver(s) are assigned.

A Sensing Measurement Setup Termination frame format is described herein. The Sensing Measurement Setup Termination frame may be used to terminate one or more sensing measurement setups. The Sensing Measurement Setup Termination frame may be transmitted by a non-AP STA or an AP-STA (e.g., by a sensing initiator or a sensing responder). The Sensing Measurement Setup Termination frame may be transmitted to one or more participants in the sensing measurement setup procedure.

FIG. 8 illustrates an example format of the Sensing Measurement Setup Termination frame. The format of the Sensing Measurement Setup Termination frame may define fields of an Action frame. As shown in FIG. 8, the Sensing Measurement Setup Termination frame 800 at least includes Measurement Setup ID Information. The Measurement Setup ID Information indicate, for example, an identifier associated with a setup instance that is to be terminated.

Methods and procedures for Sensing By Proxy (SBP) are described herein. SBP may enable a STA (e.g., a non-AP STA or an AP-STA) to obtain sensing measurements of a channel, e.g., between an AP and one or more STAs (e.g., non-AP STAs), between a multiple non-AP STAs, or between a receive antenna and a transmit antenna of an AP. With the execution of the SBP procedure, it is possible for a STA (e.g., a non-AP STA or an AP-STA) to obtain sensing measurements necessary for detecting and tracking changes in the environment. In some scenarios, a non-AP STA may act as an SBP initiator when dot11SBPImplemented is true and an AP may act as an SBP responder, for example, when dot11SBPImplemented is true. It should be understood by those of skill in the art that in other scenarios, an AP-STA may also act as an SBP initiator and a non-AP STA may also act as an SBP responder.

An SBP procedure setup is described herein. To establish an SBP procedure, the SBP initiator may send an SBP Request frame to an SBP responder capable AP. Upon receipt of an SBP Request frame, the SBP responder may for example, either: accept the SBP procedure request, in which case the SBP responder may send an SBP Response frame with status code SUCCESS; or reject the SBP procedure request, in which case the SBP responder may send a frame (e.g., an SBP Response frame) with a status code indicating that the request was rejected (e.g., with a code REQUEST_REJECTED).

The SBP responder may transmit a frame (e.g., SBP Response frame) within a given time period in response to the SBP Request frame. If no SBP Response frame is received within this time period, or if an SBP Response frame is received with a status code equal to REQUEST_REJECTED, the SBP procedure setup may be terminated. For example, one or both of the SBP initiator or the SBP responder may terminate the SBP procedure setup if one or both determine that the time period has elapsed, e.g., since the transmission of the SBP Response frame. The time period may be a configurable parameter at the SBP responder and/or at the SBP initiator.

An SBP responder that sends an SBP Response frame with status code SUCCESS may initiate a WLAN sensing procedure with one or more non-AP STAs. The SBP responder may initiate the WLAN sensing procedure using operational parameters derived from those indicated within the SBP Request frame that requested the SBP procedure. The SBP responder may be the sensing initiator of the WLAN sensing procedure. The SBP initiator may participate in the WLAN sensing procedure as a sensing responder.

The SBP Request frame format is described in greater detail herein. As described above, the SBP Request frame may be transmitted by an SBP initiator, which may be an AP-STA or a non-AP STA. The format of the SBP Request frame may define fields of an Action frame. The SBP Request frame may allow or enable a STA to invoke a SBP procedure.

FIG. 9 illustrates an example format of the SBP Request frame. As shown in FIG. 9, the SBP Request frame 900 may at least include a Dialog Token field, which may be set to a nonzero value chosen by the STA sending the SBP request. The Dialog Token field may, for example, including information that identifies the request/response transaction.

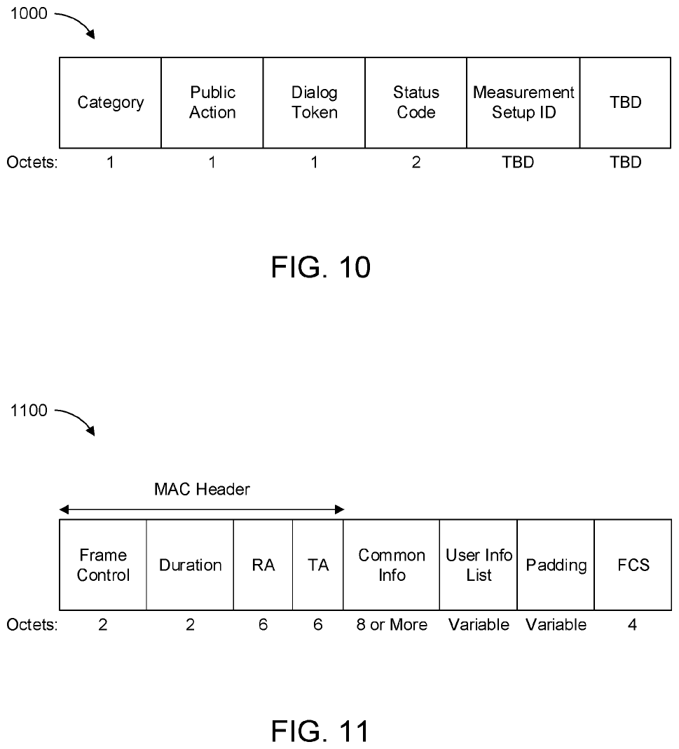

An SBP Response frame format is described herein. The SBP Response frame may be transmitted by a STA (e.g., by an AP-STA or a non-AP STA) to accept or reject a request for a SBP procedure, e.g., a request received via the SBP Request frame described substantially in paragraphs above. The format of the SBP Response frame may define fields of an Action frame. The format of the SBP Response frame Action field is described in further detail below with respect to FIG. 10.

FIG. 10 illustrates an example format of the SBP Response frame. As shown in FIG. 10, the SBP Response frame 1000 may include a Dialog Token field. The Dialog Token field may be set to the same value as the Dialog Token field of a corresponding SBP Request frame. If the STA that transmits the SBP Response frame (e.g., an AP-STA or a non-AP STA) accepts the request, the status code may indicate such success of the request. Otherwise if the AP STA rejects the request, the status code may indicate as much (e.g., the status code may be set to REQUEST_REJECTED (with a given number of octets)).

As shown in FIG. 10, the SBP Response frame 1000 may include a Measurement Setup ID field. The Measurement Setup ID field may be set to the Measurement Setup ID value corresponding to the measurement setup instance initiated by the AP that accepts the corresponding SBP request. The measurement Setup ID field may be present in an SBP Response frame, for example, if the status code indicates or is equal to SUCCESS.

Various aspects of Trigger Frames are discussed herein. Trigger frames may be implemented consistent with one or more amendments to the 802.11 specification (e.g., using High Efficiency (HE) Trigger Frame formats as set forth in 802.1 lax) to allocate resources and trigger single or multi-user access in the uplink.

FIG. 11 illustrates an example of a Trigger Frame format. As shown in FIG. 11, the Trigger Frame 1100 includes, for example, a MAC header (e.g., including a Duration field, a Receive Address (RA) field, and a Transmit Address (TA) field), a Common Info field, and a User Info List field. The Common Info field includes, for example, a Trigger Type subfield that indicates a variant of the Trigger Frame, a More TF subfield, a CS Required subfield, as well as other types of subfields.

In systems implemented in accordance with the 802.11be amendment, a new variant of the Trigger Frame format (e.g., an Extremely High Throughput (EHT) Enhanced Trigger Frame) may be used. For example, in accordance with some formats, a new variant of the User Info field may be utilized, and a Special User Info field may be added along with the Common Info field.

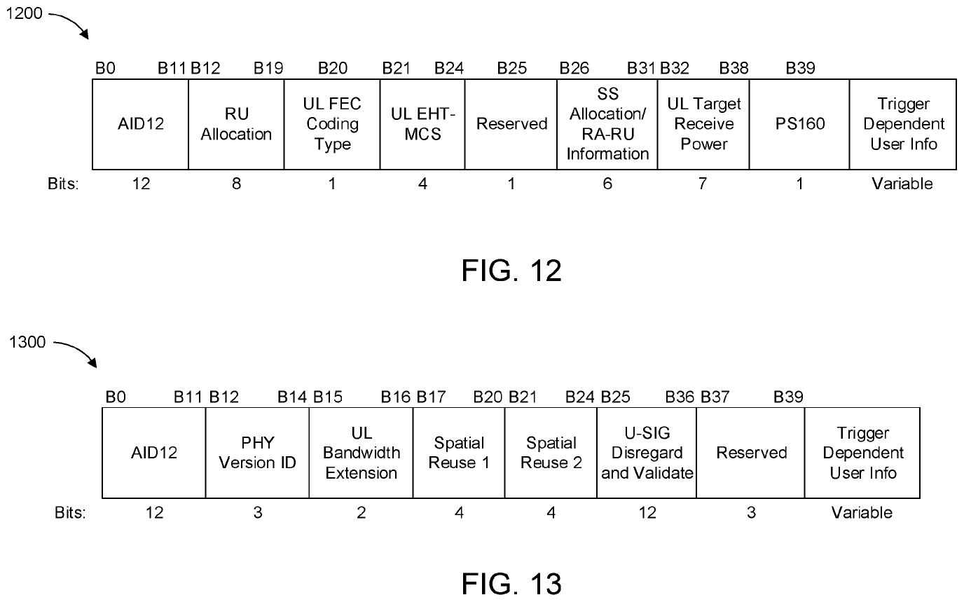

FIGS. 12 and 13 illustrates an example format of an EHT Variant User Info field and an example format of an EHT Special User Info field, respectively. FIG. 12 and FIG. 13 both illustrate enhancements that may allow, prompt, or enable a unified triggering scheme for both HE and EHT devices. As shown in FIGS. 12 and 13, the EHT Variant User Info field 1200 and the EHT Special User Info field 1300 may each include a Trigger Dependent User Info field, which may include a Trigger Type subfield indicating a subvariant of the Trigger Frame. The Trigger Dependent User Info field is described in further detail in paragraphs below.

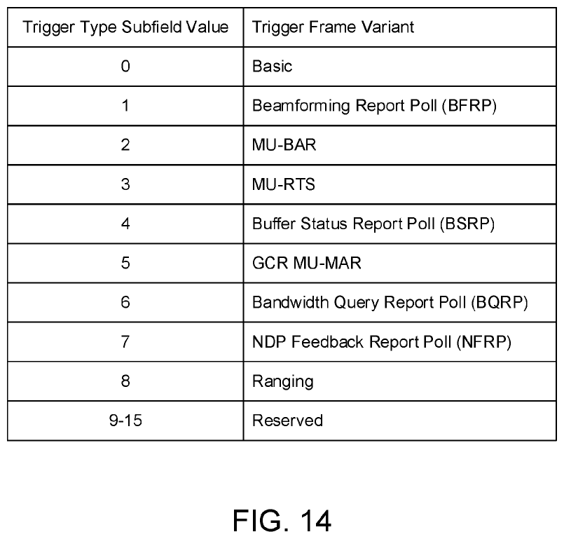

FIG. 14 is a table illustrating example encodings of the Trigger Type subfield included in the Common Info subfield of the Trigger Frame. The signaled Trigger Frame variant value may indicate a Basic Trigger Frame, a Beamforming Report Poll (BFRP) Trigger Frame, a Multi-User Block ACK Report (MU-BAR) Trigger Frame, a Multi-User Request-to-Send (MU-RTS) Trigger Frame, a Buffer Status Report Poll (BSRP) Trigger Frame, a Groupcast with Retries (GCR) MU-MAR Trigger Frame variant, a Bandwidth Query Report Poll (BQRP) Trigger Frame, an NDP Feedback Report Poll (NFRP) Trigger Frame, or the Ranging Trigger Frame variant. The Ranging Trigger variant may be one example of a Trigger Frame variant that has one or more subvariants defined. The Ranging Trigger variant and potential subvariants are described in further detail with respect to FIG. 16. The Ranging Trigger Subtype field value in the Trigger Dependent Common Info field of the Ranging Trigger frame, are also further described in paragraphs below.

FIG. 15 illustrates an example format of the Trigger Dependent Common Info subfield of a Ranging Trigger frame. A Token field in the Trigger Dependent Common Info field 1500 may be used in a Ranging Trigger frame, for example, of a Poll subvariant frame. The Token field may, for example, be matched with a Token field associated with a partial Time Synchronization Function (TSF) time in a following Ranging NDP Announcement frame. The bits used to indicate the Token may be reserved in other Ranging Trigger subvariants.

FIG. 16 is a table illustrating an example encoding of the Trigger Dependent Common Info subfield for the Ranging Trigger Frame variant. As shown in FIG. 16, the Ranging Trigger subtype may be encoded with different values for each of the subvariants Poll, Sounding, Secure Sounding, Report, and Passive TB sounding.

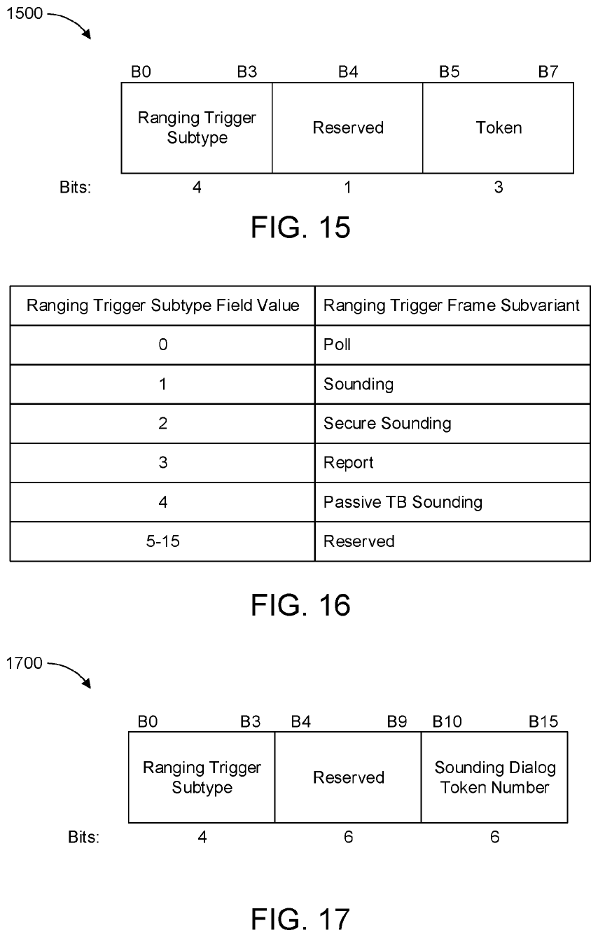

FIG. 17 illustrates another example format of the Trigger Dependent Common Info subfield of a Ranging Trigger frame. The Ranging Trigger Frame 1700 as shown in FIG. 17 may be a subvariant for Passive TB Sounding. The Sounding Dialog Token Number subfield may contain a value in the range of 0 to 63 which may identify a Measurement Sounding phase (e.g., an initiator-to-responder null data packet (I2R NDP) and responder-to-initiator null data packet (R2I NDP) announced by a Sounding Trigger frame and the Ranging NDP Announcement frame, respectively), and the same value may be included in the Sounding Dialog Token field of the Ranging NDP Announcement frame transmitted within the same Availability Window.

The RA field and the CS Required, UL BW subfields in the Common Info field of a Ranging Trigger frame variant may be identical to the Basic Trigger frame variant, except that the RA field in Ranging Trigger frames including only one User Info field may indicate unicast or broadcast addresses.

The More TF subfield of the Common Info field of the Ranging Trigger frame may be set to 1 and the RA field may be set to the broadcast address to indicate that a subsequent Ranging Trigger frame of Poll subvariant is scheduled for transmission within the availability window. The More TF subfield of the Common Info field of the Ranging Trigger frame may be set to 0 and the RA field may be set to the broadcast address to indicate that no subsequent Ranging Trigger frame of Poll subvariant is scheduled for transmission within the availability window.

The TA field for the Ranging Trigger frame may be set to the address of the responding STA (RSTA) transmitting the Trigger frame, for example, if the Trigger frame is addressed only to initiating STAs (ISTAs) with which that RSTA has a TB Ranging measurement exchange. The TA field may be the transmitted BSSID if the Trigger frame is addressed to set of ISTAs in which at least two ISTAs have a TB Ranging Measurement exchange with a different BSSID in the Multiple BSSID set of the RSTA.

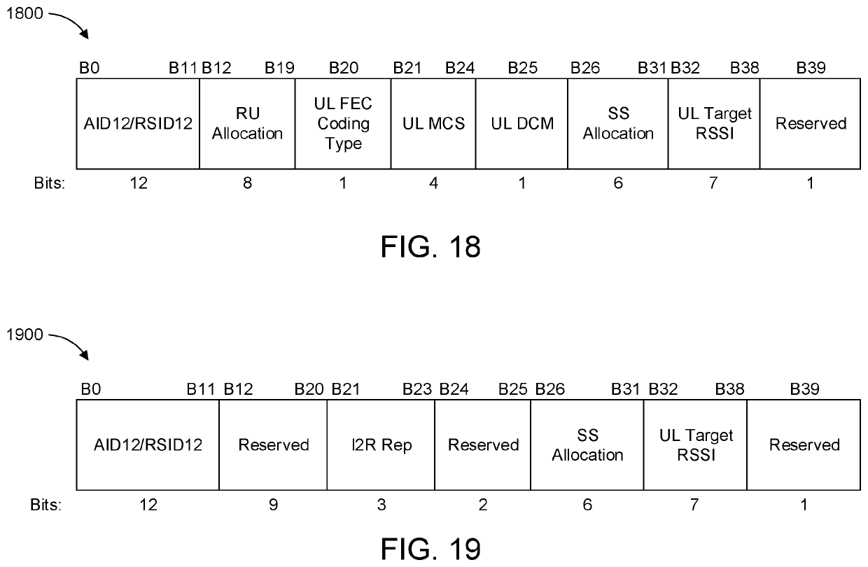

FIG. 18 illustrates an example format of the Trigger Dependent User Info field in a Ranging Trigger frame as may be included for Poll and Report subvariant frames. The Trigger Dependent User Info subfield 1800, as shown in FIG. 18, may not be present in the Poll subvariant or Report subvariant of a Ranging Trigger frame.

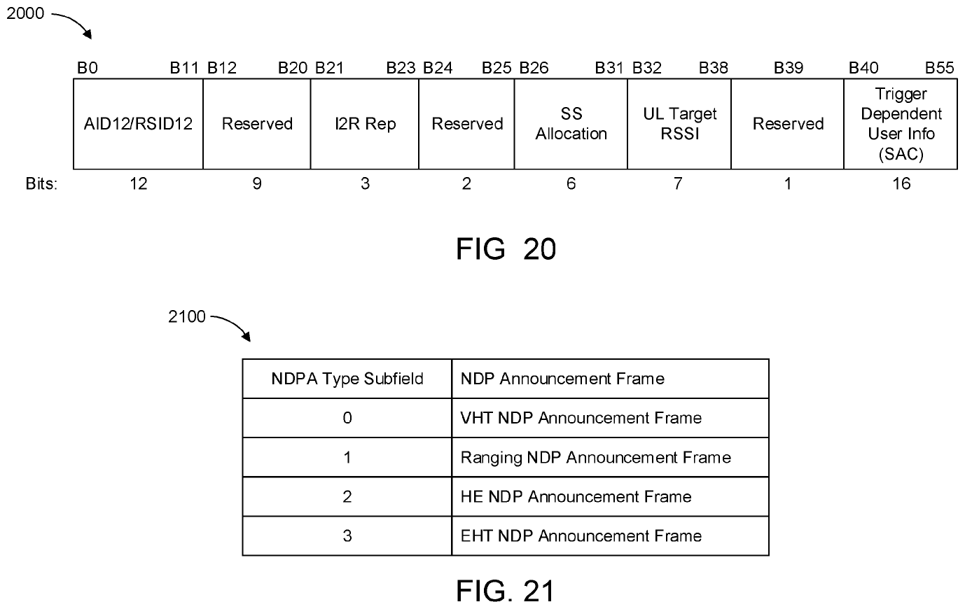

FIG. 19 and FIG. 20 illustrate example formats of the Trigger Dependent User Info field in the Sounding and Secured Sounding subvariants of a Ranging Trigger frame, respectively. The Trigger Dependent User Info field may not be present in the Sounding subvariant of the Ranging Trigger frame. As shown in FIG. 19, for example, the AID12/RSID12 subfield of the Trigger Dependent User Info fields 1900 and 2000 may carry either the 12 LSBs of the AID for an associated ISTA or the 12 LSBs of the RSID for an unassociated ISTA. The UL Target RSSI subfield may be identical to the corresponding subfield in the Basic Trigger frame. The AID12/RSID12 subfield may be identical to the corresponding subfield in the Poll subvariant of a Ranging Trigger frame. The I2R Rep subfield may signal the number of repetitions N_REP of the HE LTF symbols in the corresponding HE TB Ranging NDP from the STA indicated in the AID12/RSID12 subfield. The value of the I2R Rep subfield may be the same in all User Info fields in the Trigger frame. The SS Allocation and UL Target RSSI subfields may be identical to the corresponding subfields in the Basic Trigger frame.

As shown in FIG. 20, for example, the AID12/RSID12 subfield may be identical to the corresponding subfield in the Poll subvariant of a Ranging Trigger frame. The I2R Rep subfield may signal the number of repetitions N_REP of the HE LTF symbols in the corresponding HE TB Ranging NDP from the STA indicated in the AID12/RSID12 subfield. The SS Allocation and UL Target RSSI subfields may be identical to the corresponding subfields in the Basic Trigger frame. The Trigger Dependent User Info subfield may be present in the Secured sounding subvariant of a Ranging Trigger frame as depicted in FIG. 20. The Trigger Dependent User Info subfield may carry the Security Authentication Code (SAC) field. The SAC field may provide the authentication information for the LTF Sequence Generation information used for 12R sounding associated with the measurement instance. The length of this subfield may be 16 bits.

The Passive TB Ranging subvariant of a Ranging Trigger frame may follow the definition of the Sounding subvariant of a Ranging Trigger frame, except that the RA field may always be set to the broadcast address and the I2R Rep subfield may signal the number of repetitions N_REP of the HE LTF symbols in the corresponding HE Ranging NDP from the STA indicated in the AID12/RSID12 subfield.

The transmission of an NDPA frame may initiate an NDPA-based sounding or sensing procedure. For example, the NDPA may inform participant(s) (i.e., non-AP STA(s) and/or AP-STA(s)) of an NDP PPDU that is about to be transmitted and a sounding or sensing procedure is about to start. An NDPA may also include the sounding or sensing requirements. A sensing transmitter may then transmit the NDP PPDU, which has no payload but includes LTF symbols that enable the participant(s) to measure the wireless channel. The participant(s) may then report their respective channel measurements, using methods as are described in further detail herein. NDPA Variants are described herein. In systems implemented in accordance with 802.11 specifications, there may be four variants of the NDPA as listed in FIG. 21.

FIG. 21 illustrates an example encoding of a NDP Announcement variant frame. As shown in FIG. 21, an NDPA Type subfield included in the NDP Announcement frame may indicate that the NDP Announcement frame is a VHT NDP Announcement frame, a Ranging NDP Announcement frame, an HE NDP Announcement frame, or an EHT NDP Announcement frame.

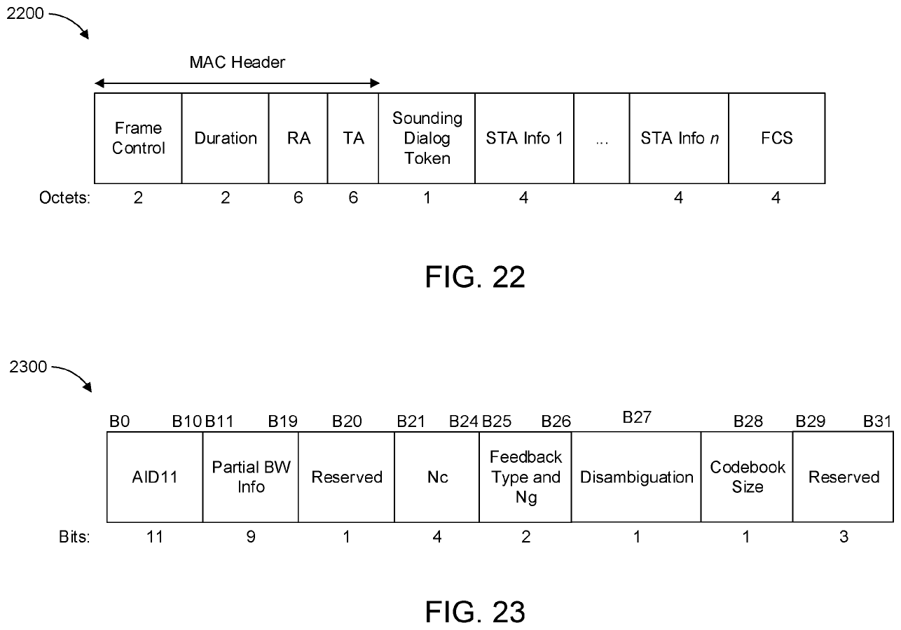

FIG. 22 illustrates an example of an NDP Announcement frame format. As shown in FIG. 22, an NDP Announcement frame may include a MAC header (e.g., including a Duration field, an RA field, and a TA field), a Sounding Dialog Token, and one or more STA Info fields. Those of skill in the art will appreciate that the example format of the NDP Announcement frame shown in FIG. 22 may be applicable to, e.g., HE NDP Announcement frames, Ranging NDP Announcement frames, and/or EHT NDP Announcement frames.

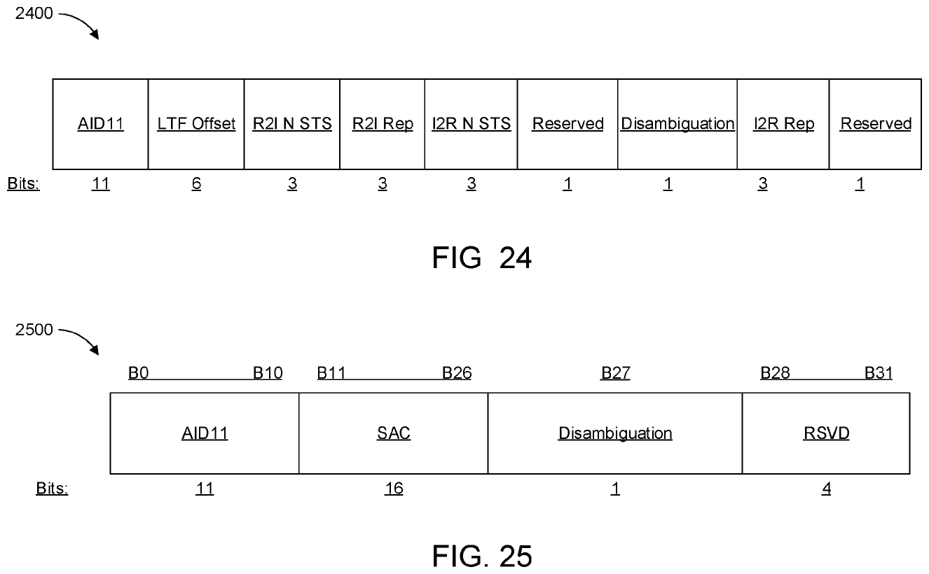

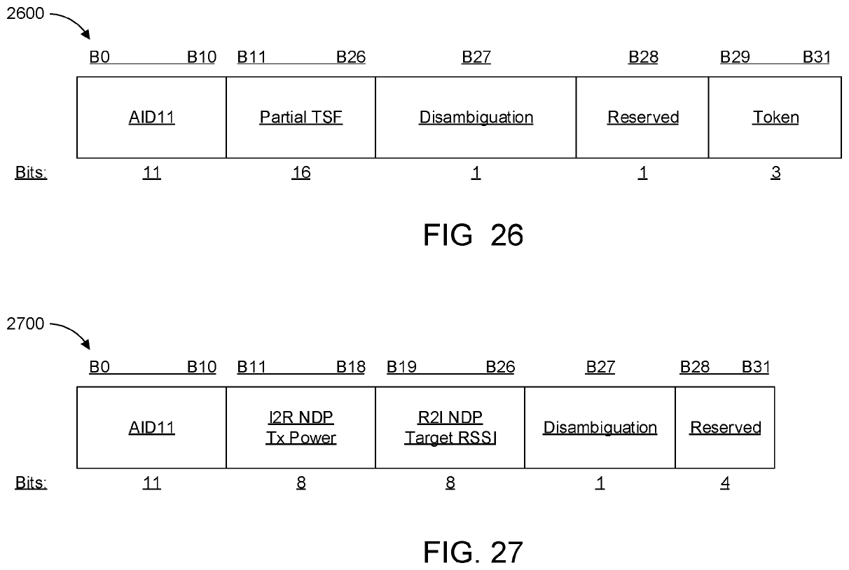

FIG. 23 illustrates an example of the STA Info field of the EHT NDPA variant. FIGS. 24-27 illustrate example formats of the Special STA Info field of the HE Ranging NDP Announcement frame variant. Specifically, FIG. 24 illustrates an example format of the Special STA Info field when the AID 11 subfield has a value of less than 2008. FIG. 25 illustrates an example format of the Special STA Info field when the AID11 subfield has a value of 2043. FIG. 26 illustrates an example format of the Special STA Info field when the AID11 subfield has a value of 2044. FIG. 27 illustrates an example format of the Special STA Info field when the AID11 subfield has a value of 2045.

Preamble puncturing is a feature that may be implemented consistent with, for example, 802.11ax, to allow a STA to transmit on certain subchannels but not the entire bandwidth. In other words, a punctured transmission of a PPDU may have no signal present in one or more subchannels within the PPDU bandwidth. In 802.11 be, two type of preamble puncturing schemes are defined: static puncturing and dynamic puncturing.

With static puncturing, one or more subchannels may be punctured for one or more beacon intervals. An AP may include a field, such as a Disabled Subchannel Bitmap field in the EHT Operation element, to indicate that one or more subchannels are disabled. STAs may set the TXVECTOR parameter INACTIVE_SUBCHANNELS of an HE, EHT, or non-HT duplicate PPDU based on the value indicated in a previously exchanged (e.g., the most recently exchanged) Disabled Subchannel Bitmap field in the EHT Operation element for that BSS. STAs may not transmit anything on the disabled subchannels.

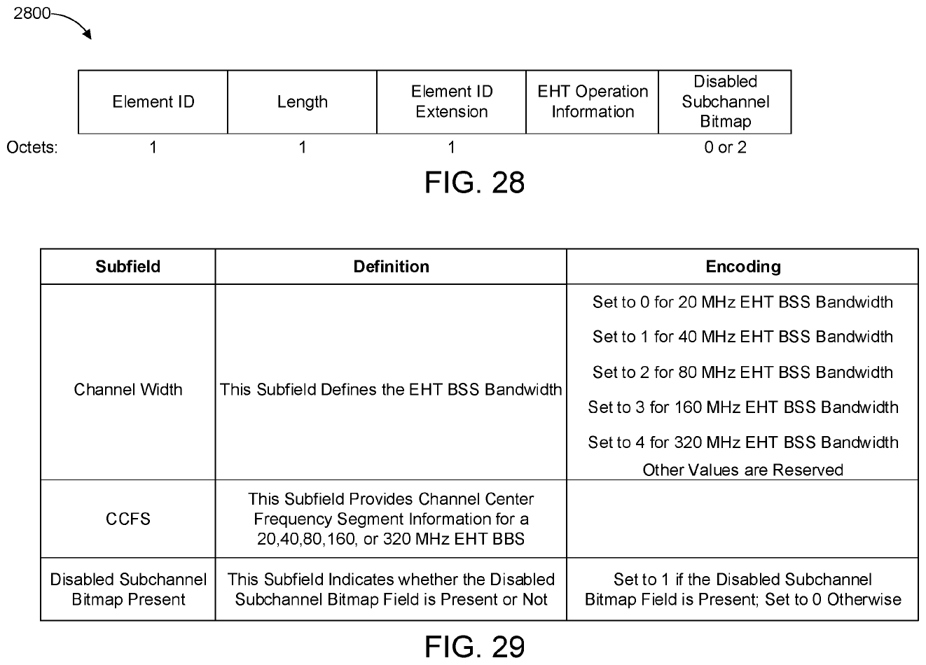

FIG. 28 illustrates an example format of the EHT Operation element. As shown in FIG. 28, the EHT Operation element 2800 includes an Element ID field, a Length field, an Element ID Extension field, an EHT Operation Information field, and/or a Disabled Subchannel Bitmap (e.g., as described above). The Disabled Subchannel Bitmap may be 2 octets long, for example, if present.

FIG. 29 illustrates an example format of the EHT Operation Information field. The EHT Operation Information field may include subfields as shown in FIG. 29 including a Channel Width subfield, a CCFS subfield defining channel center frequency segment information, and/or a Disabled Subchannel Bitmap Present subfield, which may indicate whether the Disabled Subchannel Bitmap field is present in the EHT Operation element. The encoding of the Channel Width subfield may indicate, for example, that the EHT BSS bandwidth is 20 MHz, 40 MHz, 80 MHz, 160 MHz, or 320 MHz.

A valid puncturing pattern may be defined consistent with 802.11 standards. With dynamic puncturing, however, a STA may be allowed to puncture additional subchannels other than those indicated by the Disabled Subchannel Bitmap field. The STA may determine to puncture additional subchannels for different reasons. For example, such puncturing may be based on its physical or virtual channel sensing results. Dynamic puncturing may be, for example, explicitly signaled using U-SIG field in EHT MU PPDU. A Punctured Channel Information field may be carried in a U-SIG field of an EHT MU PPDU to indicate the punctured channels.

Various problems addressed by solutions proposed herein may be described as follows. Some problems may concern procedures for sensing role negotiation. In TB measurement instances or non-TB measurement instances, a sensing initiator may not know the full status of the sensing responder. Due to the availability (or unavailability) of the sensing responder, e.g., channel availability, data buffer status, power availability, etc., the sensing responder may not be able to act as the sensing role(s) assigned or suggested by the sensing initiator. Therefore, there may be a need to define a set of procedures of sensing role negotiation which allow the sensing responder to suggest its sensing role in the TB or non-TB measurement instance.

Some problems may concern enhanced procedures for non-TB measurement instances with multiple STAs. Consistent with 802.11bf specifications, non-TB sensing measurement instances may be considered pairwise, i.e., a non-AP STA may be the initiator, and an AP may be the sensing responder. The sensing initiator (or the sensing responder) may be either a sensing transmitter, sensing receiver, or both. In some scenarios, other non-AP STAs which may not be the sensing initiator may want to participate in this sensing measurement instance. For example, the AP may want to send the NDP to multiple non-AP STAs, which may include the sensing initiator. Alternatively, or additionally, when the AP is the sensing receiver, it may want to receive the NDP from multiple non-AP STAs, which may include the sensing initiator. However, there may be no defined procedure to indicate how multiple non-AP STAs which are not the sensing initiator can participate in the non-TB measurement instance. Therefore, there may be a need to define an efficient procedure to reduce the signaling overhead and signaling time when multiple non-AP STAs which are not the sensing initiator participate in the non-TB measurement instance.

Some problems may concern SBP procedures with multiple SBP requesters. Consistent with 802.11bf specifications, Sensing-by-Proxy (SBP) is a procedure that may allow or enable a non-AP STA to request an AP to perform WLAN sensing on its behalf. There may be scenarios in which more than one non-AP STA would like to request the AP to perform WLAN sensing on their behalf. There may be no defined procedure to enable multiple non-AP STAs to request the AP to perform SBP simultaneously.

Some problems may concern enhanced procedures for sensing measurement termination with multiple STAs. Consistent with 802.11bf specifications, sensing measurement termination procedures may not be defined, especially given there is may be no clear specification as to how to efficiently terminate multiple STAs when these STAs have the same sensing measurement ID, e.g. serve the same applications. Therefore, there may be a need to define an efficient sensing measurement termination procedure for multi-STAs to reduce the sensing signaling overhead.

Some problems may concern procedures for estimating the number of participating sensing responders per TXOP. In existing 802.11bf specs, each TB sensing measurement instance may be limited by the duration of the TXOP. The TB sensing measurement instance may include one or more of each of the following phases: a Polling phase, NDPA Sounding phase, TF Sounding phase, and/or Reporting phase. As the number of sensing responders grows, a TB sensing measurement instance may include multiple Polling phases, multiple TF Sounding phases, multiple NDPA Sounding phases, and/or multiple Reporting phases. The number of phases that may be accommodated in one TXOP may be limited by the duration of this TXOP. A computation procedure may be required to estimate the number of phases, and hence, the number of responders that may participate in one TB measurement instance given the duration of the TXOP.

Various solutions addressing at least some of the problems described in paragraphs above are provided herein. Some embodiments may concern procedures for sensing role negotiation. TB sensing measurement setup negotiation procedures may be a subset of such procedures.

Some scenarios addressed may involve one sensing initiator (AP) negotiating with one sensing responder (non-AP STA). In one such scenario, the AP, which may be the sensing initiator, may send the sensing measurement setup request to one non-AP STA, acting as a sensing responder. This measurement setup procedure may allow or enable negotiation between the sensing initiator, AP and the sensing responder, non-AP STA.

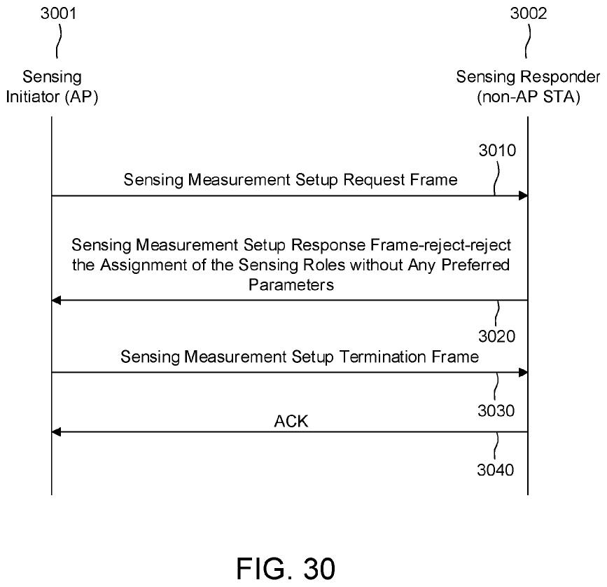

FIG. 30 illustrates an example WLAN sensing procedure for TB measurement setup negotiation. As shown in FIG. 30, a sensing initiator 3001 (e.g., an AP-STA, as shown in FIG. 30) performs TB measurement setup negotiation with a sensing responder 3002 (e.g., a non-AP STA as shown in FIG. 30) by transmitting a Sensing Measurement Setup Request frame 3010 to the sensing responder 3002. Upon receipt of the Sensing measurement Setup Request frame 3010, the sensing responder 3002 may not accept the assigned sensing roles indicated in the Sensing Measurement Setup Request frame 3010 (e.g. it may not be available to set up sensing measurement or it may not agree on the sensing roles assigned by the sensing initiator). The sensing responder 2902 may transmit a Sensing Measurement Setup Response frame 3020 to the sensing initiator. The Sensing Measurement Setup Response frame 3020 may include a field or value that indicates “Reject”. Upon receipt of the Sensing Measurement Setup Response frame with the indication of Reject, the sensing initiator 3001 may send a Sensing Measurement Setup Termination frame 3030 to terminate the sensing measurement set up procedure. The sensing responder 3002 may send an ACK as shown at 3040 to acknowledge the reception of Sensing Measurement Setup Termination frame 3030.

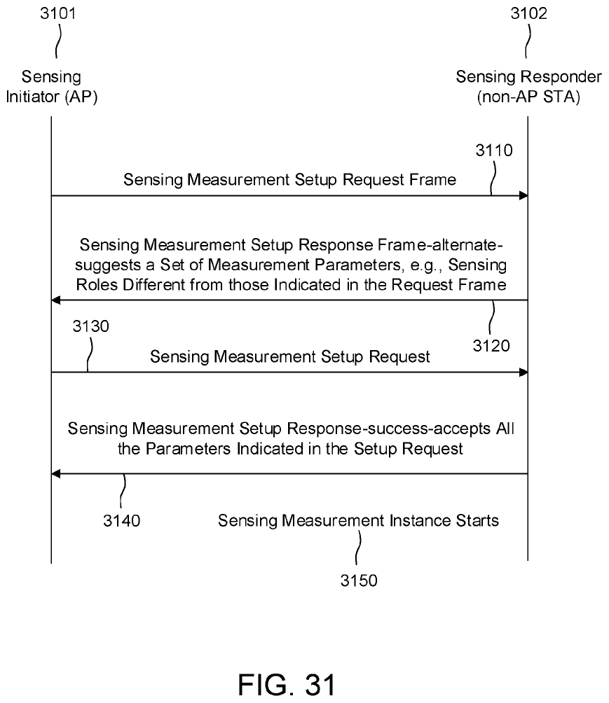

FIG. 31, illustrates an exemplary WLAN sensing procedure for TB measurement setup negotiation in which an alternate response is received from the sensing responder. As shown in FIG. 31, the sensing initiator 3101 (e.g., an AP-STA) transmits a Sensing Measurement Setup Request frame 3110 to at least the sensing responder 3102 (e.g., a non-AP STA), similarly as describe above with respect to FIG. 30. Upon receipt of the Sensing measurement Setup Request frame 3110, the sensing responder 3102 may not accept the assigned sensing roles indicated in the Sensing Measurement Setup Request frame 3110. The sensing responder 3102 may transmit a Sensing Measurement Setup Response frame 3120 to the sensing initiator 3101. The Sensing Measurement Setup Response frame 3120 may include a field or a value that indicates “Alternate”. In addition, as shown in FIG. 31, the sensing responder 3102 may also include a set of suggested parameters in the Sensing Measurement Setup Response frame 3120, e.g., the sensing roles it prefers to take in the sensing measurement instance. Upon receipt of the Sensing Measurement Setup Response frame 3120 from the sensing responder 3102, the sensing initiator 3101 may again transmit a Sensing Measurement Setup Request frame (shown in this instance at 3130) to indicate new sensing measurement parameters. The sensing responder 3102 may again send a Sensing Measurement Setup Response frame (shown at 3140) with afield or value indicating “Accept”. Alternatively, or additionally it may repeat the negotiation process and send the Sensing Measurement Setup Response with “Alternate” or “Reject’. When the sensing responder 3102 transmits (or when the sensing initiator 3101 receives) the Sensing Measurement Setup Response frame 3140 with “Accept” indication, the sensing measurement instance may start, as shown at 3150.

If the sensing responder sends another Sensing Measurement Setup Response frame including an “Alternate” indication, the sensing initiator may need to confirm the alternative sensing measurement parameters suggested by the sensing responder. For example, the sensing initiator may send the Sensing measurement Setup Request again. The system may limit the number of the Sensing Measurement Setup Request frames transmitted from the sensing initiator. For example, the maximum number of transmitted Sensing Measurement Setup Request frames may be set equal to 2. The system may limit the number of the Sensing Measurement Setup Response frames transmitted from the sensing responder. For example, the maximum number of transmitted Sensing Measurement Setup Response frames (e.g., the maximum number of transmitted Sensing Measurement Response frames that include an “Alternate” indication) may be set equal to 2. In some cases, the system may limit the negotiation duration between the sensing initiator and the sensing responder, for example, by configuring a timer. When the time duration expires, the sensing measurement setup may be terminated, or the sensing responder may utilize the sensing measurement parameters indicated in the latest Sensing Measurement Setup Request frame to start the sensing measurement instance or the sensing initiator may utilize the alternative sensing measurement parameters indicated in the latest Sensing Measurement Setup Response frame to start the sensing measurement instance.

Some scenarios may involve one sensing initiator (e.g., an AP-STA or a non AP-STA) sending a sensing measurement setup request to multiple sensing responders (e.g., non-AP STAs or AP-STAs). For example, in some of such scenarios, an AP, acting as the sensing initiator, may send a sensing measurement setup request to a group of non-AP STAs, acting as sensing responders simultaneously. In such measurement setup procedures, this may allow negotiation between the sensing initiator (e.g., AP) and multiple sensing responders (e.g., non-AP STAs). These sensing responders may belong to the same group, which may be indicated in various messaging by a group ID.

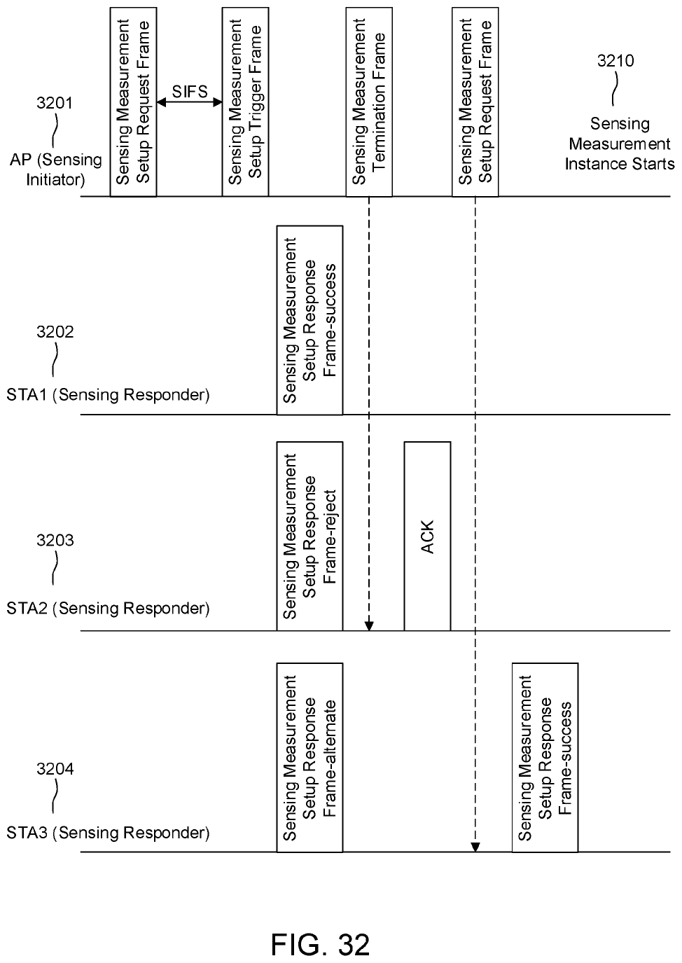

FIG. 32 depicts an exemplary sensing procedure for TB measurement setup negotiation between one sensing initiator and multiple sensing responders where multiple responders have different responses indicated in Measurement Setup Request frame. As shown in FIG. 32, the sensing initiator AP 3201 may send the Sensing Measurement Setup Request frame to multiple sensing responders, e.g., non-AP STAs 3202, 3203, and 3204. The Sensing Measurement Setup Trigger frame may be transmitted by the sensing initiator 3201 a SIFS after the Sensing Measurement Setup Request frame. An RU allocation for the transmissions of multiple Sensing Measurement Setup Response frames from multiple STAs may be included in this Trigger frame. Upon the receipt of the Sensing Measurement Setup Trigger frame, the requested STAs 3202, 3203, and 3204, which may belong to one group of sensing responders, each send Sensing Measurement Setup Response frames using the RU allocation indicated by the Trigger frame. The sensing responders 3202, 3203, and 3204 may indicate different responses. As shown in FIG. 32, the sensing responder 3202, STA1, may send a Sensing Measurement Setup Response frame indicating “Accept”; the sensing responder 3203, STA2 may send a Sensing Measurement Setup Response frame indicating “Reject”; and the sensing responder 3204, STA3, may send a Sensing Measurement Setup Response frame indicating “Alternate”. After receiving the Sensing Measurement Setup Response frames from multiple responders, the sensing initiator 3201 may take different actions with respect to each sensing responder: the sensing initiator may send a Sensing Measurement Termination frame to sensing responder 3203 (STA2) which may be replied to with an ACK. This may means that the sensing measurement setup between the AP and has not been completed. The sensing initiator 3201 may send a Sensing Measurement Setup Request frame including alternative sensing setup parameters suggested by sensing responder 3204 (STA3) to the sensing initiator 3204. Upon receipt of the new Sensing Measurement Setup Request frame, sensing responder 3204 may send a Sensing Measurement Setup Response with the indication “Accept” to the sensing initiator 3201. After the exchange of all these frames, the sensing measurement setup is successfully completed between the sensing initiator 3201 and the sensing responders 3202 and 3204. There may be no sensing measurement setup procedure completed between sensing initiator 3201 and 3203. It may be for the sensing initiator (e.g., the AP) as to which sensing responder (e.g., STA) should be contacted first after the receipt of Sensing Measurement Setup Response frames from multiple sensing responders.

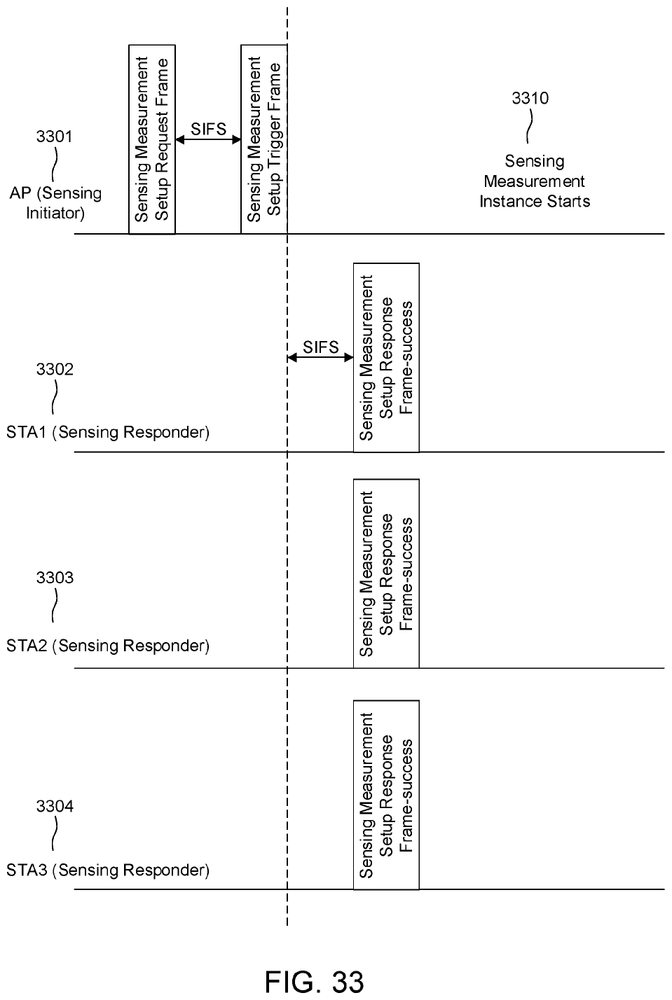

FIG. 33 illustrates an example sensing procedure for TB measurement setup negotiation between a sensing initiator and multiple sensing responders in which all of the responders accept the sensing measurement parameters indicated in a Measurement Setup Request frame. As shown in FIG. 33, the sensing initiator AP 3301 may send a Sensing Measurement Setup Request frame to multiple sensing responders, e.g., non-AP STAs 3302, 3303, and 3304. Once the sensing initiator 3301 receives a Sensing Measurement Setup Response frame (e.g., from each of the sensing responder 3302, 3303, and 3324), the sensing initiator 3301 may start the sensing measurement instance, as shown at 3310.

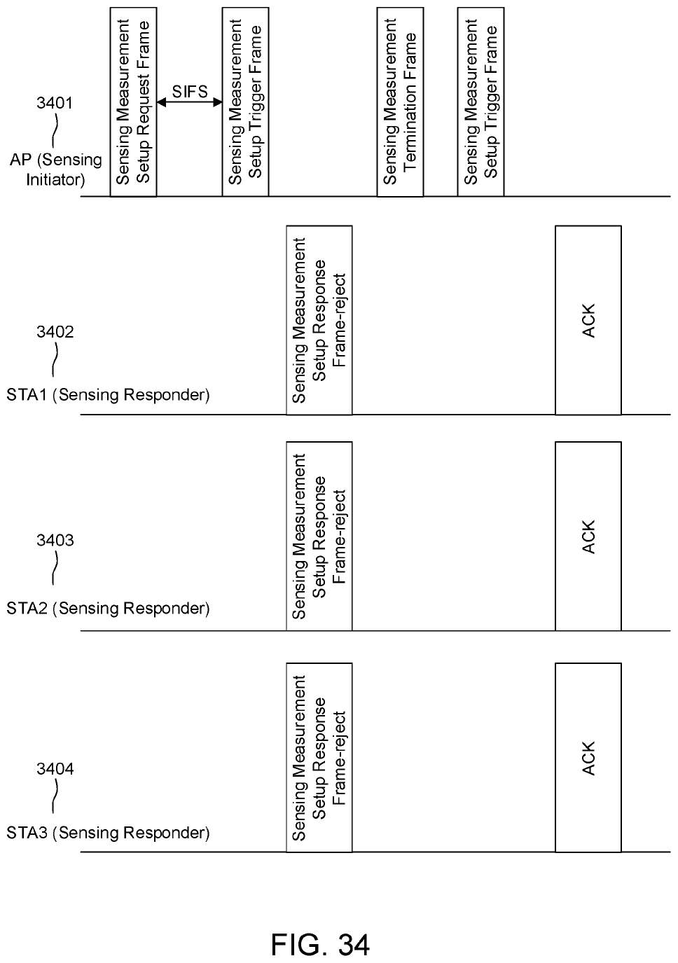

FIG. 34 illustrates an example sensing procedure for the TB measurement setup negotiation carried out between one sensing initiator and multiple sensing responders, in which all of the responders reject the sensing measurement parameters indicated in Measurement Setup Request frame. As shown in FIG. 34, the sensing initiator AP 3401 may send a Sensing Measurement Setup Request frame to multiple sensing responders, e.g., non-AP STAs 3402, 3403, and 3404. In such examples, upon receipt of the Sensing Measurement Response frame indicating “Reject” from all sensing responders, the sensing initiator 3401 may send all responders a Sensing Measurement Termination frame which may be followed by a Trigger frame (e.g., Sensing Measurement Setup Trigger frame). The Sensing Measurement Termination frame may be transmitted after a subframe in a SIFS. The sensing responders 3402, 3403, and 3404, may send an ACK, for example, a SIFS after receipt of the Trigger frame.

Non-TB sensing measurement setup negotiation procedures are described herein. In non-TB sensing measurement instances, a non-AP STA may be the sensing initiator, and an AP may be the sensing responder. Before the sensing measurement instance starts, the sensing measurement parameters indicated in the Sensing Measurement Request frame between the sensing initiator, the non-AP STA and the sensing responder, the AP, are negotiated. The sensing responder AP may accept, reject, alternate, or demand the sensing measurement parameters indicated in a Sensing Measurement Request frame.

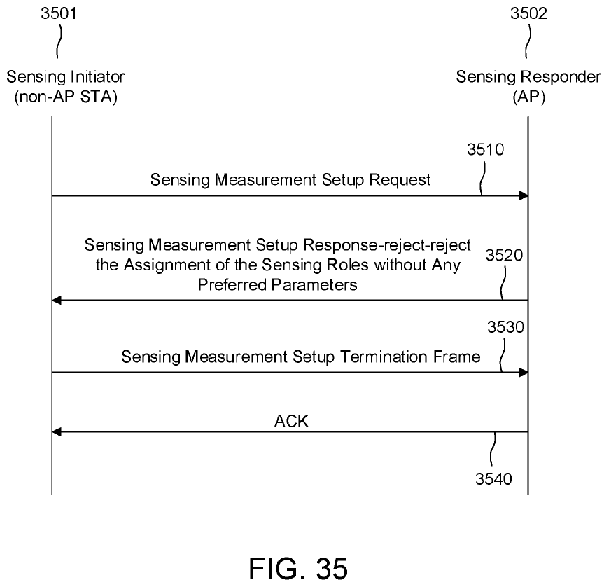

FIG. 35 illustrates an example of a non-TB measurement setup negotiation procedure carried out between the sensing initiator (non-AP STA) and the sensing responder (AP). In this example shown in FIG. 35, a sensing initiator 3501 may transmit a Sensing Measurement Setup Request frame 3510 to a sensing responder 3502. The sensing responder 3502 may indicate Reject in the Sensing Measurement Setup Response frame 3520. In other words, the sensing responder 3502 may not accept the sensing measurement parameters indicated in the Sensing Measurement Setup Request frame 3510 and may not provide any alternative parameters. Once the sensing initiator 3501 has received the Sensing Measurement Setup Response 3520 including the Reject indication, the sensing initiator 3501 may terminate the sensing measurement setup, i.e., by sending out a Sensing Measurement Setup Termination frame 3530, which may be followed by an ACK 3540 from the sensing responder 3510.

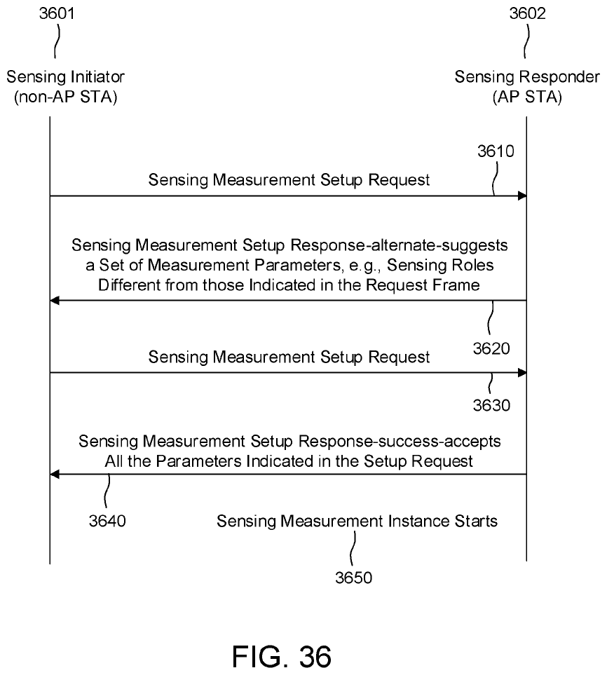

FIG. 36 illustrates an example of a non-TB measurement setup negotiation procedure involving a sensing initiator (e.g., a non-AP STA) and a sensing responder (e.g., an AP). In this example shown in FIG. 36, a sensing initiator 3601 may transmit a Sensing Measurement Setup Request frame 3610 to a sensing responder 3602. The sensing responder 3602 may indicate Alternate in a Sensing Measurement Setup Response frame 3620. In the Sensing Measurement Setup Response frame 3620, the responder 3602 may include alternative sensing measurement parameters. The sensing initiator 3601 may accept these parameters and implement or include these parameters in a subsequent Sensing Measurement Setup Request frame 3630, which may be sent to the responder 3602. Alternatively, or additionally, the indication of the Alternate value in the Sensing Measurement Setup Response frame 3620 may allow, prompt, or enable another negotiation process between the sensing initiator 3601 and the sensing responder 3602. The system may limit number of the negotiation times, e.g., the maximum negotiation times which may be equivalent to the maximum transmission numbers of the Sensing Measurement Request frames equal to 2. Alternatively, or additionally, the system may set up a timer to limit the negotiation duration. When the timer expires, in some cases, the sensing measurement setup may be terminated, or in some cases the sensing responder 3602 may implement or accept the sensing measurement parameters indicated in the latest Sensing Measurement Setup Request frame to start a sensing measurement instance. In some cases, the sensing initiator 3601 may implement or accept the alternative sensing measurement parameters indicated in the latest Sensing Measurement Setup Response frame to start the sensing measurement instance.

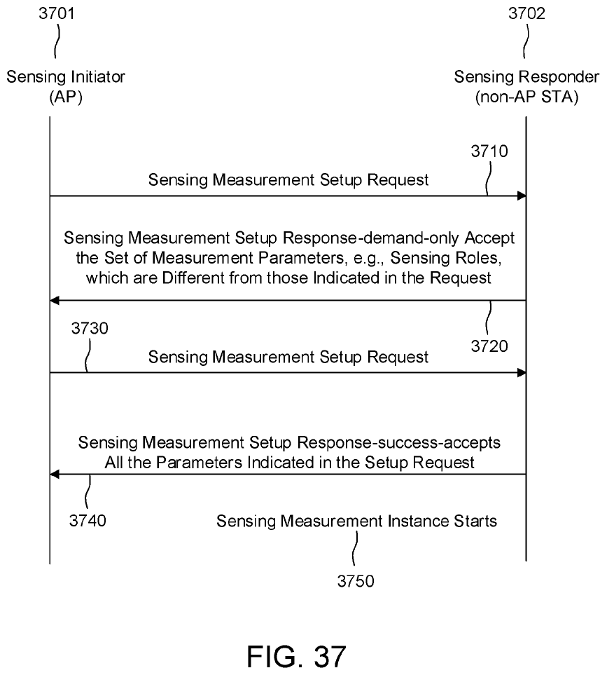

FIG. 37 illustrates an exemplary non-TB measurement setup negotiation procedure involving a sensing initiator (e.g., a non-AP STA) and the sensing responder (e.g., an AP). As shown in FIG. 37, a sensing initiator 3701 may transmit a Sensing Measurement Setup Request frame 3710 to a sensing responder 3702. The sensing responder may transmit a Sensing Measurement Setup Response frame 3720 and include a value that indicates “Demand”. The Sensing Measurement Setup Response frame 3720 may include an indication of parameters that differ from the parameters that were included in the Sensing Measurement Setup Request frame 3710. “Demand” may indicate the sensing responder may only accept the sensing parameters indicated in the sensing Measurement Setup Response frame 3720. If, for example, the sensing initiator 3601 accepts or agrees with the demanded sensing parameters, the sensing initiator 3701 may send a subsequent Sensing Measurement Setup Request frame 3730 which may include the demanded sensing parameters. As illustrated in FIG. 37, the sensing responder 3702 may transmit a subsequent Sensing Measurement Setup Response 3740 including a value indicating success of the setup procedure and acceptance of the parameters indicated in the subsequent Sensing Measurement Setup Request 3730. As shown at 3750, the Sensing Measurement instance may then commence.

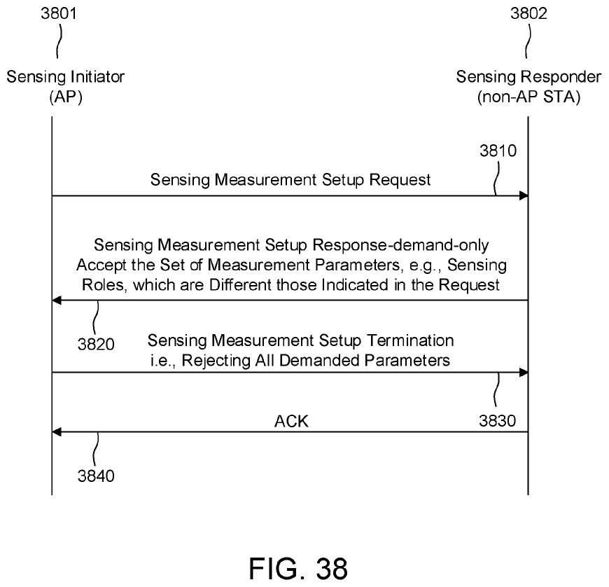

FIG. 37 illustrates another exemplary non-TB measurement setup negotiation procedure involving a sensing initiator (e.g., a non-AP STA) and the sensing responder (e.g., an AP). As shown in FIG. 38, a sensing initiator 3801 may transmit a Sensing Measurement Setup Request frame 3810 to a sensing responder 3802. The sensing responder may transmit a Sensing Measurement Setup Response frame 3820 and include a value that indicates “Demand”. The Sensing Measurement Setup Response frame 3820 may include an indication of parameters that differ from the parameters that were included in the Sensing Measurement Setup Request frame 3810. If the sensing initiator 3801 does not agree with the demanded sensing parameters, it may terminate the sensing measurement setup by transmitting a Sensing Measurement Setup Termination message, as shown at 3830. The sensing responder 3802 may transmit an ACK in response to the sensing initiator 3801.

Solutions involving sensing measurement set up response frames are described herein. Sensing Measurement Setup Response frame Action field formats are further discussed herein.

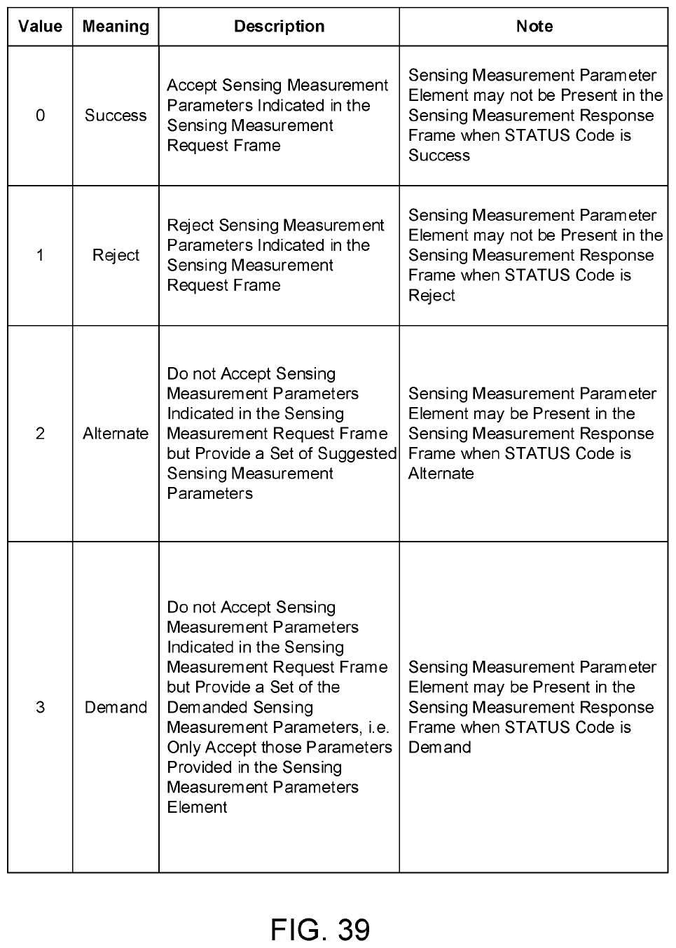

FIG. 39 is a table illustrating an exemplary encoding for a Status Code subfield in the Sensing Measurement Setup Response frame. The Status Code subfield may include, for example, information indicating Success, Reject, Alternate, Demand, or other values. The Status Code subfield may include, for example, an indication of partial acceptance of the parameters included in a Sensing Measurement Setup Request frame. Partial acceptance may occur, for example, when a participant (e.g., a transmitter of a Sensing Measurement Setup Response frame) accepts some of, or a portion of, the parameters indicated in the Sensing Measurement Setup Request frame.

It should be noted that the sensing roles from one sensing measurement instance to another sensing measurement instance may be changed. Therefore, the sensing role negotiation procedure may be required in each sensing measurement setup.

Embodiments relating to enhanced procedures for of Non-TB measurement instances involving multiple STAs are described herein. In non-TB measurement instances, for example, in which a non-AP STA is a sensing initiator and an AP is the sensing responder, other non-AP STAs may be enabled to participate in this sensing measurement instance. The non-AP STA may be the sensing transmitter, the sensing receiver or both.

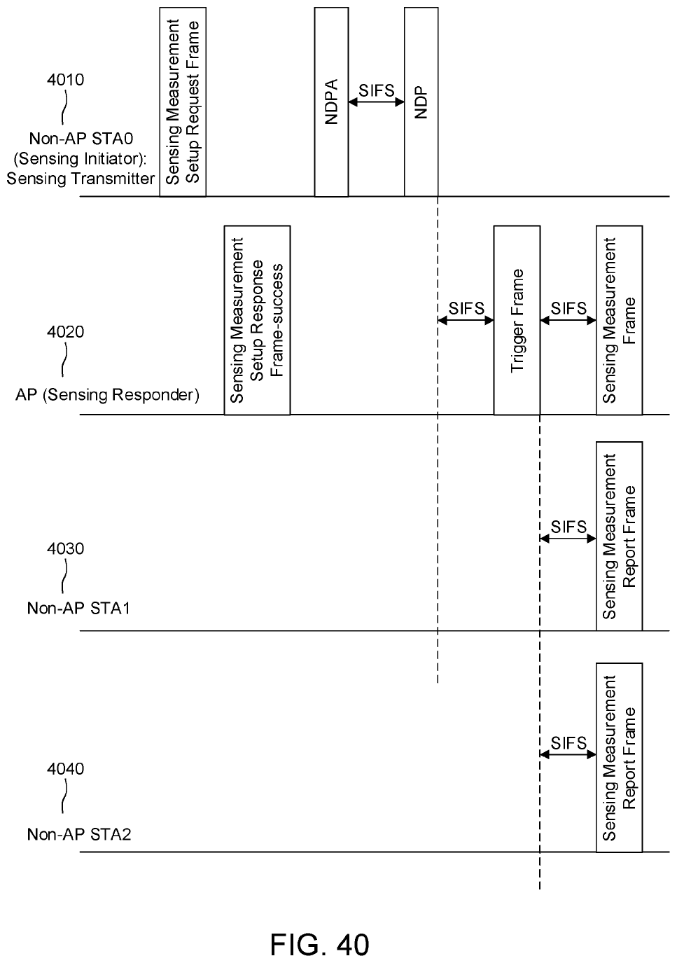

FIG. 40 illustrates a non-TB measurement instance in which an initiator (e.g., a Non-AP STA0) is the sensing transmitter and AP and other non-AP STAs (e.g., Non-AP STA1, non-AP STA2) are sensing receivers. In the example shown in FIG. 40, the sensing initiator 4010 (i.e., the Non-AP STA0) may send a Sensing Measurement Setup Request frame. A sensing responder 4020 (i.e., an AP) may transmit a Sensing Measurement Setup Response frame to the sensing initiator 4010 in response. In the Sensing Measurement Setup Response frame, the sensing responder 4020 may indicate that it accepts all of the sensing measurement parameters indicated in the Sensing Measurement Setup Request frame transmitted by the sensing initiator 4010. The sensing responder 4020 (AP) may indicate in the response frame that its associated STAs, e.g., non-AP STA 4030 (STA1) and non-AP STA 4040 (STA2) agree to participate in the sensing measurement setup. Upon receipt of the Sensing Measurement Setup Response frame with a Success Indication, the sensing initiator (i.e., Non-AP STA0) may transmit an NDP Announcement (NDPA) frame, which may be followed by one or more NDPs. The one or more NDPs may be transmitted, for example, a SIFS after the NDPA. At a SIFS after the transmission of an NDP, the sensing responder (i.e., the AP) may transmit a trigger frame to a non-AP STA 4030 (i.e., STA1) and a non-AP STA 4040 (i.e., STA2) which may indicate resource allocation information for transmission of Sensing measurement Report frames by non-AP STA 4030 and non-AP STA 4040. At a SIFS after the Trigger frame, the sensing responder 4020, non-AP STA 4030 and non-AP STA 4040 may send Sensing Measurement Response frames, which may be received by the sensing initiator 4010 (i.e., non-AP STA0). Sensing results may carried in the Sensing Measurement Report frame.

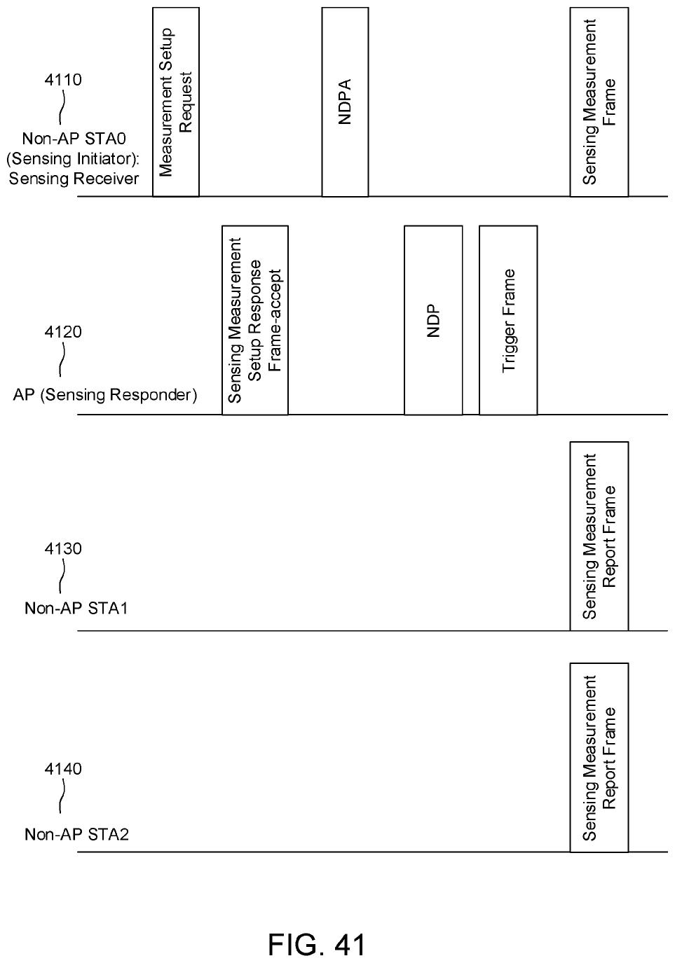

FIG. 41 illustrates a non-TB measurement instance in which the initiator, e.g., Non-AP STA0, and other non-AP STAs are sensing receivers and a sensing responder (i.e., an AP) is the sensing transmitter. In the example shown in FIG. 41, the sensing initiator 4110 (i.e., non-AP STA0) sends a Sensing Measurement Setup Request frame. The Sensing Measurement Setup Response frame is followed by a Sensing Measurement Setup Response frame from the sensing responder 4120 (i.e., an AP). In the Sensing Measurement Setup Response frame, the sensing responder may indicate it accepts all sensing measurement parameters included in the Sensing Measurement Setup Request frame transmitted by the sensing initiator 4110. The sensing responder 4120 (AP) may indicate in the response frame that its associated STAs, e.g., non-AP STA 4130 (STA1) and non-AP STA 4140 (STA2) agree to participate in the sensing measurement setup. Upon receipt of the Sensing Measurement Setup Response frame with the Success Indication, the sensing initiator may transmit an NDP Announcement (NDPA) frame, followed after a SIFS by the transmission of an NDP. The NDP may be transmitted, for example, by the sensing responder 4120 (i.e., the AP). A SIFS after the NDP, the sensing responder 4120 may send a trigger frame to other participants 4110, 4130, and 4140 (i.e., to non-AP STA0, non-AP STA1 and non-AP STA2) and indicate resource allocation information for Sensing measurement Report frames to be transmitted by the other participants 4110, 4130, and 4140 (i.e., non-AP STA0, non-AP STA1 and non-AP STA2). A SIFS after Trigger frame, the sensing initiator 4110 (i.e., non-AP STA0), non-AP STAs 4130 and 4140 (i.e., STA1 and STA2) may send Sensing Measurement Report frames that may be received by the sensing responder 4120 (i.e., the AP). Sensing results may be carried in a Sensing Measurement Report frame, not shown in FIG. 41.

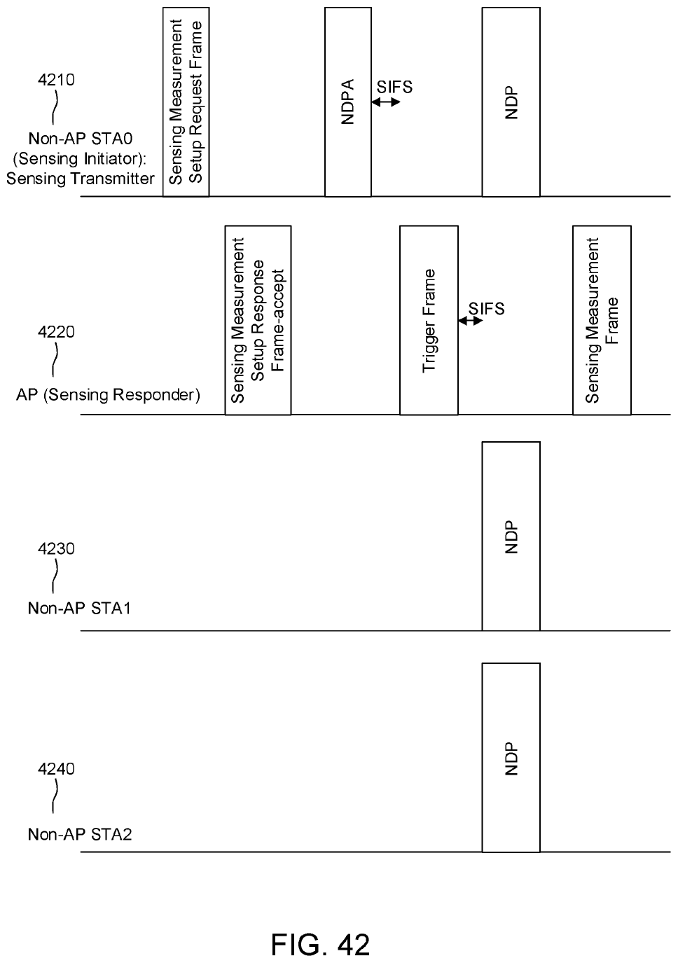

FIG. 42 illustrates an example of a non-TB measurement instance in which a sensing initiator, e.g., Non-AP STAG and other non-AP STAs are sensing transmitters and an AP is a sensing receiver. As shown in FIG. 42, the sensing initiator 4210 (i.e., Non-AP STA0) may send a Sensing Measurement Setup Request frame, which may be followed by a Sensing Measurement Setup Response frame transmitted by the sensing responder 4220 (i.e., an AP). In the Sensing Measurement Setup Response frame, the sensing responder 4220 may indicate it accepts all the sensing measurement parameters indicated in the Sensing Measurement Setup Request frame transmitted by the sensing initiator 4210 (i.e., non-AP STA0). The sensing responder 4220 (AP) may indicate in the response frame that its associated STAs, e.g., non-AP STA 4230 (STA1) and non-AP STA 4240 (STA2) agree to participate in the sensing measurement setup. Upon receipt of the Sensing Measurement Setup Response frame including the Accept Indication, the Non-AP STA0 may transmit an NDP Announcement (NDPA) frame, which may be followed after a SIFS by a Trigger frame transmitted by the sensing responder 4220 (i.e., the AP). The Trigger frame may be sent to other participants 4210, 4230 and 4240 (i.e., non-AP STA0, non-AP STA1 and non-AP STA2) and may indicate resource allocation information for transmission of Sensing measurement Report frame(s) by the participants 4210, 4230, and/or 4240 (i.e., non-AP STA0, non-AP STA1 and/or non-AP STA2). A SIFS after the Trigger frame, the sensing responder (i.e., the AP) may send a Sensing Measurement Report frame which may be received by the participants 4210, 4230, and/or 4240 (i.e., non-AP STA0, non-AP STA1 and/or non-AP STA2). Sensing results may be carried in a Sensing Measurement Report frame, not shown in FIG. 42.

To enable participants (i.e., non-AP STA1 and non-AP STA2) to participate in the sensing measurement instance initiated by the sensing initiator (i.e., non-AP STA0) and to send sensing results to the sensing initiator and/or the sensing responder (i.e., the non-AP STA0 or AP), one or more optional procedures may be undertaken. In some cases, an NDPA may be sent by the sensing initiator (i.e., non-AP STA0), which may include STA information for the participants (i.e., non-AP-STA1 and non-AP-STA2) and indicate that such participants are sensing receivers or/and sensing transmitters and which device is the sensing transmitter. For example, non-AP STA0 may be the sensing transmitter in the example shown in FIG. 40, the AP may be the sensing transmitter in the example shown in FIG. 41. Non-AP STA0, non-AP STA1 and non-AP STA2 may be sensing transmitters in the example shown in FIG. 42.

In some options, non-AP STAs may be grouped. For example, if any non-AP STA from the same group or the group head non-AP STA acts as a sensing initiator and transmits the NDPA, the remaining non-AP STAs in that group may perform as sensing receivers or transmitters and send the sensing results to that sensing transmitter if there is a need (e.g., non-AP STAG may be the sensing transmitter in the example shown in FIG. 40, AP may be the sensing transmitter in the example shown in FIG. 41, and non-AP STA0, non-AP STA1 and non-AP STA2 may be sensing transmitters as shown in FIG. 42). One or more Group IDs may be included in the NDPA and/or in the Trigger frame. An indication of the group head may be included in the NDPA and/or in the Trigger frame in some cases.

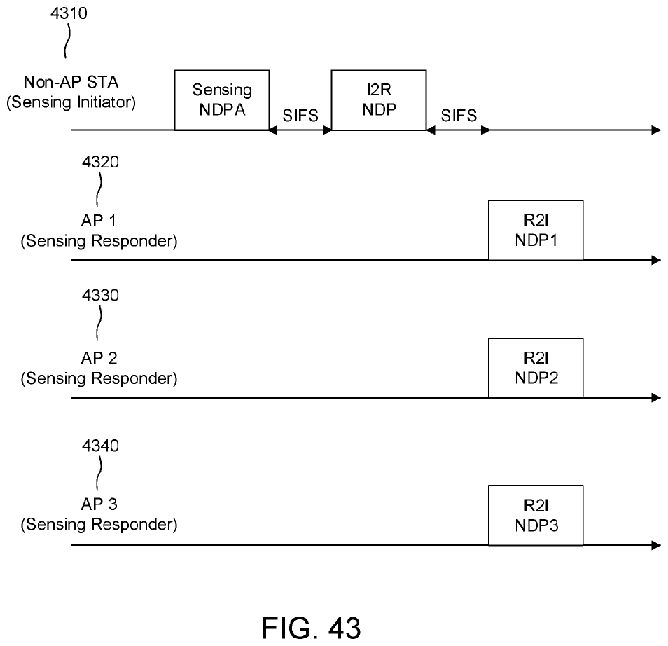

Simultaneous non-TB sensing measurement instances in multi-AP scenarios are described herein. In some embodiments, a non-AP STA may initiate a non-TB sensing measurement instance with one or more APs in a multi-AP scenario such that the non-AP STA may be the sensing initiator, and the APs of the Multi-AP group may be the sensing responders participating in the sensing session. The aforementioned scenario may be illustrated and described further in paragraphs below with respect to the example of FIG. 43.

FIG. 43 illustrates an exemplary frame exchange between a non-AP STA initiating multiple simultaneous non-TB sensing measurement instances with different APs in a Multi-AP group. As shown in FIG. 43, the sensing initiator 4310 is a non-AP STA and sensing responders 4320, 4330, and 4340 are APs (i.e., AP1, AP2, and AP3). The sensing initiator 4310 transmits a sensing NDPA frame, which is followed by an I2R NDP PPDU after a SIFS. Subsequently, after another SIFS, the sensing responders 4320, 4330, and 4340 transmit R2I NDP PPDUs in response.

In some embodiments, the non-AP STA may be the sensing transmitter and some or all the APs of the Multi-AP group participating in the sensing session may be the sensing receivers. In some methods, the non-AP STA may send a Sensing NDPA with one STA Info field addressed to a group AID or a Special AID to provide the configuration information for the I2R NDP which may be sent by the non-AP a SIFS after the NDPA. Some or all APs of the Multi-AP group may then send the R2I NDP a SIFS after the I2R NDP. The Sensing NDPA may be used to configure the R2I NDP to be transmitted with minimum possible length with one LTF. In some methods, the non-AP STA may send the Sensing NDPA with many STA Info fields, and each may be addressed to one of the APs in the Multi-AP group participating in the sensing session. The configurations of the R2I NDP may be the same or different in each STA Info field. In some methods, the non-AP STA may configure one AP to send the R2I NDP while other APs in the Multi-AP group may remain silent and not respond with R2I NDPs. The AP to send the R2I NDP may be the sharing AP of the Multi-AP group, or it may be the associated AP of the non-AP STA initiating the sensing session.

In some embodiments, the non-AP STA may be the sensing receiver and all the APs of the Multi-AP group participating in the sensing session may be the sensing transmitters. The non-AP STA may send the Sensing NDPA followed by an I2R NDP after a SIFS and the APs of the Multi-AP group may send an R2I NDP after a SIFS. In some methods, the non-AP STA may send the Sensing NDPA with one STA Info field addressed with a group AID or a Special AID. The STA Info field may be used to configure the I2R NDP to be transmitted with minimum possible length with one LTF. The Sensing NDPA may also be used to configure the transmission of the R2I NDP from different APs of the Multi-AP group participating in the sensing session. When only one STA Info field is used, the APs may respond by sending the R2I NDP with the same configuration indicated in this STA Info field. In some methods, the only STA Info field may be used to allocate different resources for the different APs to send the R2I NDPA. In some methods, the non-AP STA may send the Sensing NDPA with many STA Info fields, and each may be addressed to one of the APs in the Multi-AP group participating in this sensing session. The STA Info field may be used to configure the R2I NDP transmitted from different APs with different configurations. The R2I NDPs may then be sent either multiplexed in time, frequency, or spatial domains or any combinations of the three domains. The R2I NDPs may also be sent using the same time, frequency, and spatial domain in non-orthogonal manner.

In some embodiments, the non-AP STA may be a sensing transmitter and receiver and some of the APs of the Multi-AP group participating in the sensing session are sensing transmitters and some are only sensing receivers. The non-AP STA may send the Sensing NDPA followed by an I2R NDP after a SIFS and then the APs of the Multi-AP group may send an R2I NDP after a SIFS. In one method, the non-AP STA may send the Sensing NDPA with two STA Info field each is addressed with a group AID or a Special AID such that one is used for the AP sensing transmitters and one for the AP sensing receivers. The AP sensing transmitters STA Info field may be used to configure the R2I NDP to be transmitted from the APs acting as sensing transmitters. The AP sensing receivers STA Info field may be used to configure the I2R NDP to be transmitted from the non-AP STA to the APs acting as sensing receivers. In some methods, the non-AP STA may send the Sensing NDPA with many STA Info fields, and each may be addressed to one of the APs in the Multi-AP group participating in this sensing session. The STA Info field may be used to configure the R2I NDP transmitted from different APs acting as sensing transmitters with different configurations. The R2I NDPs may then be sent multiplexed in time, frequency, or spatial domains or any combinations of the three domains. The R2l NDPs may also be sent using the same time, frequency, and spatial domain in non-orthogonal way. Also, the STA Info field may be used to configure the I2R NDP transmitted from the non-AP STA to the different APs acting as sensing receivers.

In some embodiments, when the non-AP STA is acting as both a sensing transmitter and a receiver, the I2R NDP and the R2I NDPs may be used in both directions to perform measurements such that the non-AP STA may acquire CSI for the links between itself and the APs acting as sensing transmitters or acting as sensing transmitters and receivers using the R2I NDP and in the same time the AP acting as a sensing transmitter and receiver may acquire CSI for the link between itself and the non-AP STA using the I2R NDP.

Embodiments relating to SBP procedures involving multiple SBP requests are described herein. In SBP procedures, a non-AP STA may be enabled or prompted to obtain sensing measurements of the channel between an AP and one or more non-AP STAs. In such cases, there may be a scenario in which multiple non-AP STAs may send SBR requests to the AP during a time interval T_out, which may be defined by the system. In this scenario, enhanced procedures that enable or prompt an AP to send one or more SBP responses to these SBP initiators simultaneously or consecutively is proposed. These methods may improve signaling efficiency and reduce overhead.

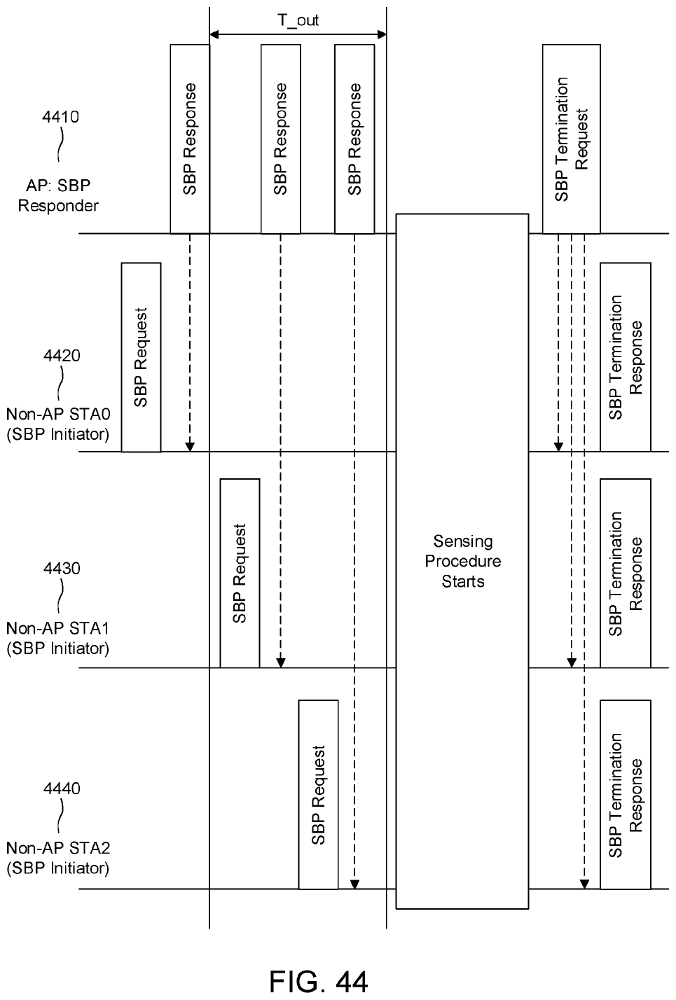

FIG. 44 illustrates an exemplary SBP procedure involving multiple SBP initiators. In the example shown in FIG. 44, an SBP initiator 4420 (i.e., non-AP STA0) may first send an SBP request to the SBP responder 4410 (i.e., an AP). The SBP request may be followed a SIFS after by a SBP response from the SBP responder 4410. A timer may begin to run (i.e., the SBP responder 4410 may determine when a time duration has elapsed starting from when the first SBP request is received by the sensing responder 4410). Before T_out expires, or before the time duration elapses, the SBP responder 4410 may receive another SBP request from SBP initiator 4430 (i.e., non-AP STA1). After the message exchange of SBP request and SBP response between SBP initiator 4430 and SBP responder 4410 and the time from the counting start point is less than T_out, another SBP request may be received by the SBP responder 4410 from the SBP initiator 4440. After the SBP responder 4410 sends an SBP Response frame to SBP initiator 4440, the elapsed time duration may reach T_out. All three SBP initiators may belong to the same group or request similar contents, e.g., use same the applications or same CSI information related to similar or the same channels. The SBP responder 4410 may decide to initiate a single sensing procedure for these SBP initiators at the same time. The SBP responder 4410 may terminate the SBP procedure, i.e., send a SBP Termination Request at any time to one or more of the three SBP initiators 4420, 4430, and/or 4440 simultaneously or non-simultaneously. The time interval or duration, e.g., Tout, may be used to limit the time duration during which the SBP Requests from the same SBP group of STAs are received can be merged as one SBP procedure. Alternatively, or additionally, any one of the SBP initiators may terminate the SBP procedure.

In some embodiments, a non-AP STA may send the SBP Request frame to the AP, which may be an SBP responder. Upon receipt of the SBP request, the SBP responder may identify that the SBP initiator belongs to a group of non-AP STAs and decide to send another SBP Response frame to other non-AP STAs that are in the same group as the SBP initiator.

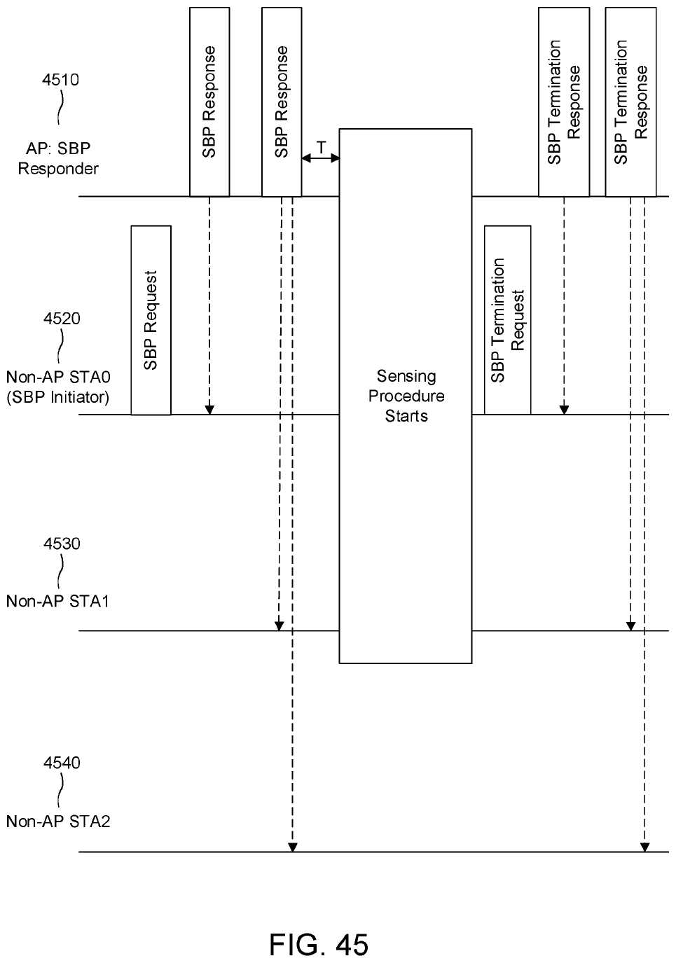

FIG. 45 illustrates an exemplary SBP procedure involving a single SBP initiator and a group of SBP participants that includes multiple SBP participants. In the example shown in FIG. 45, the SBP initiator 4520 (i.e., non-AP STA0), may include its group ID in an SBP Request frame. Upon receipt of the SBP request from SBP initiator 4520, an SBP responder 4510 (i.e., an AP) may identify the group ID and decide to send another SBP request to non-AP STA 4530 (i.e., STA1 and non-AP STA 4540 (i.e., STA2), which may indicate the sensing procedure may start at a time interval of T, which may begin at the end of the reception of the SBP response. For example, T may be equal to aSIFTime+aSlotTime+aRxPHYStartDelay. Once this group of non-AP STAs joins the SBP procedure, the requirements (e.g., sensing measurement and/or reporting requirements) set by the SBP initiator may be applied to all group members or the active group members. For example, the required sensing measurement results may be sent to non-AP STA 4520, and/or non-AP STA 4530 and/or non-AP STA 4540 in this case. The SBP responder 4510 may terminate the SBP procedure by sending the SBP Termination Request frame. In this example, the SBP initiator 4520 (i.e., non-AP STA0) may indicate any of the following information in a SBP Request frame: 1) an SBP group ID; and/or 2) information allowing no group members, a portion of the group members, or all group members to participate in the SBP procedure. If the SBP initiator 4520 non-AP STA0 does not allow any other non-AP STAs to participate in this SBP procedure, the SBP responder 4510 (i.e., the AP) may not send the SBP Response frame to other group members. If the SBP initiator 4520 (i.e., non-AP STA0) only allows a portion of the group members to participate in this SBP procedure, then the SBP responder 4510 (i.e., the AP) may only send the SBP Response frame to those which are allowed to join this SBP procedure. If the SBP initiator 4520 (i.e., non-AP STA0) allows all group members to participate in this SBP procedure, then the SBP responder 4510 (i.e., the AP) may send the SBP Response frame to all group members of non-AP STA0. In this example, SBP initiator 4520 (i.e., non-AP STA0) may initiate the SBP termination procedure. The SBP responder 4510 may send the SBP Termination Response frame to non-AP STA 4520 first and then send a separate frame to non-AP STA 4530 (non-AP STA1) and non-AP STA 4540 (non-AP STA2). Alternatively, the SBP responder 4510 may send one SBP Termination Response frame to non-AP STA 4520, non-AP STA 4530 and non-AP STA 4540. Alternatively, or additionally, the SBP responder 4510 (i.e., the AP) may terminate the SBP procedure, or other group members may terminate the SBP procedure if they participate in this SBP procedure.

Embodiments relating to sensing measurement termination involving multiple STAs are described herein. Sensing measurement termination initiated by the AP may be performed as described in the following paragraphs. In some embodiments, a sensing measurement termination procedure involving one AP and multiple non-AP STAs may be proposed. In such procedures, an AP may be the sensing initiator and initiates the termination of the sensing measurement.

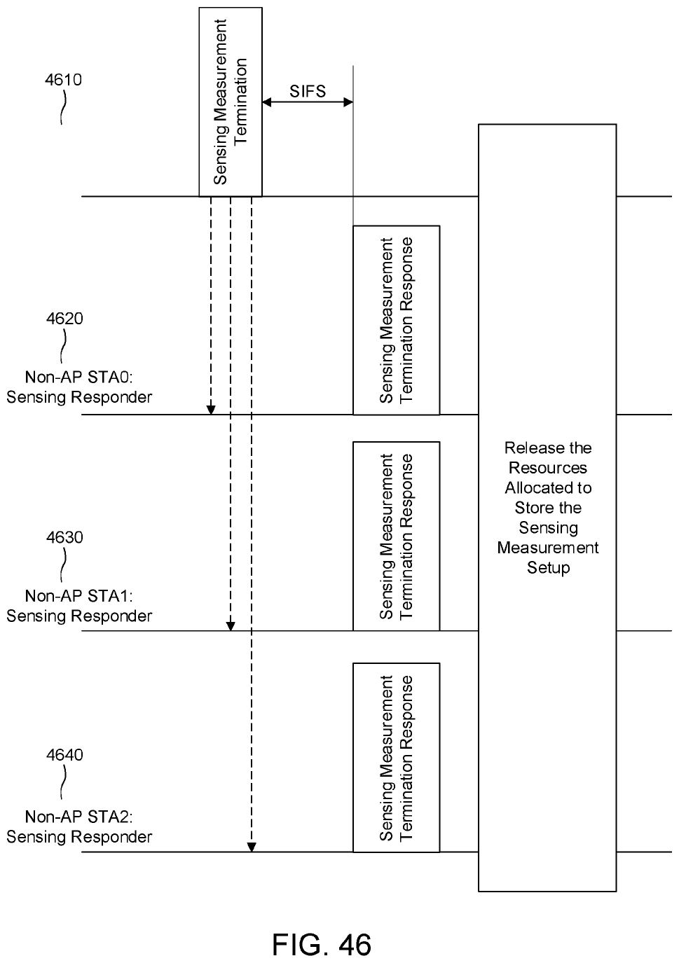

FIG. 46 illustrates an example of a procedure for sensing measurement termination initiated by an AP, where the AP may be the sensing initiator. As shown in FIG. 46, the sensing initiator 4610 (i.e. the AP) may send a Sensing Measurement Setup Termination frame to sensing responders 4620, 4630, and 4640 (i.e., the intended STA or STAs). A period of time, e.g., aSIFS, after the reception of the Sensing Measurement Setup Termination frame, the sensing responders 4620, 4630, and 4640 that are indicated as the recipients of this Sensing Measurement Setup Termination frame may either send ACKs or Sensing Measurement Setup Termination Response frames to the sensing initiator 4610. After the ACK or response frame, the sensing initiator 4610 and the recipient sensing responders 4620, 4630, and 4640 may release the resources allocated for the terminated sensing measurement instance.

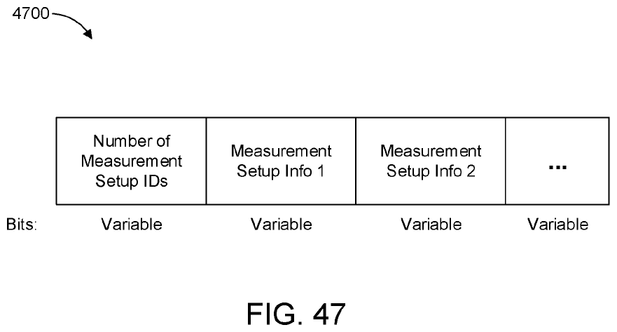

FIG. 47 illustrates an example of the exemplary Measurement Setup ID Information subfield in the Sensing Measurement Setup Termination frame Action field. As shown in FIG. 47, the Measurement Setup ID Information subfield may include various information as follows. For example, the subfield may include a Number of Measurement Setup IDs. This may indicate the number of Measurement Setup Info subfields that follow the Number of Measurement Setup IDs subfield.

The information included in one or more Measurement Setup Info subfields may include one or some of the following information. In some examples, a sensing measurement setup ID and MAC addresses of the STAs associated with this sensing measurement ID may be included. A STA that is associated with this sensing measurement ID and/or associated with the indicated MAC address may decode the Sensing Measurement Setup Termination frame and terminate the sensing measurement associated with the indicated sensing measurement setup ID.

In some examples, a sensing measurement ID and/or STA_IDs of the STAs associated with this sensing measurement ID may be included. A STA that is associated with this sensing measurement ID and/or associated with the indicated STA_ID may decode the Sensing Measurement Setup Termination frame and terminate the sensing measurement associated with the indicated sensing measurement setup ID. It should be noted that one sensing measurement ID may provide an indication of multiple STAs.

In some examples, a sensing measurement setup ID and/or the STA_ID or MAC address of the sensing initiator associated with sensing measurement ID may be included. A STA associated with this sensing measurement ID that has the corresponding sensing initiator with the indicated STA_ID or MAC address may decode the Sensing Measurement Setup Termination frame and terminate the sensing measurement associated with the indicated sensing measurement setup ID.

In some examples, a sensing measurement setup ID and the sensing group ID may be included. A STA that is associated with this sensing measurement ID and/or associated with the sensing group ID may decode the Sensing Measurement Setup Termination frame and terminate the sensing measurement associated with the indicated sensing measurement setup ID.

A value in the Number of Measurement Setup IDs subfield may indicate the number of Measurement Setup Info subfields that follow the Number of Measurement Setup IDs. It should be noted, however, that other examples of the Measurement Setup ID Information subfield format may be possible. The subfield may be present in other formats that includes the elements list above. In addition, sensing session termination may serve to terminate sensing by all STAs that are involved in the same sensing measurement instance identified with the sensing measurement ID. Sensing session termination may terminate sensing by a portion of the STAs that are involved in the same sensing measurement instance. It should be noted that the roles mentioned above may be applied to termination procedures initiated by an AP that is not the sensing initiator.

Embodiments relating to sensing measurement termination initiated by a non-AP STA are described herein. In some cases, termination of the sensing session may be initiated by a non-AP STA.

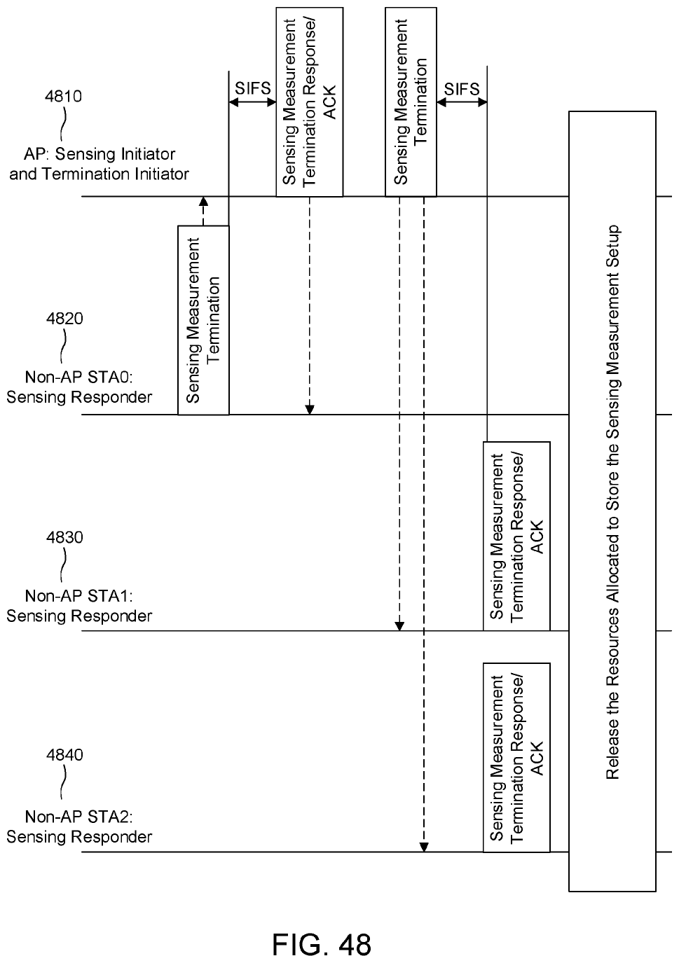

FIG. 48 illustrates an exemplary sensing measurement setup termination procedure initiated by a non-AP STA. In the example shown, a sensing responder/termination initiator 4820 (i.e., non-AP STA0) may send a message indicating Sensing Measurement Termination to a sensing initiator/termination initiator 4810 (i.e., an AP), which may indicate a Measurement Setup ID and/or the non-AP STAs involved in the same measurement instance. The sensing initiator/termination initiator 4810 may follow the same or similar procedures as illustrated, for example, in FIG. 45 and may use format illustrated in FIG. 47, to notify other non-AP STAs that are involved in the same measurement setup. Alternatively, or additionally, the sensing termination initiator 4820, e.g., non-AP STA0, may include a group ID in the Sensing Measurement Termination frame. After A period of time, e.g., SIFS, following receipt of the Measurement Termination frame, the sensing initiator/termination responder 4810 may first send the Sensing Measurement Termination Response frame or ACK to sensing responder 4820 (i.e., non-AP STA0) and then send another Sensing Measurement Termination frame to other responders 4830 and 4840 (i.e., non-AP STAs, STA1 and STA2). After a period of time, e.g., SIFS, following receipt of the Sensing Measurement Termination, sensing responder 4830 and 4830 (i.e., non-AP STA1 and non-AP STA2) may send Sensing Measurement Termination Responses and/or ACKs to the sensing initiator/termination responder 4810. The resources allocated for this sensing measurement instance may be released.

Embodiments relating to procedures for estimating the number of participating sensing responders per TXOP are described herein. Solutions disclosed in this embodiment may be used to address at least one of the problems defined in paragraphs above.

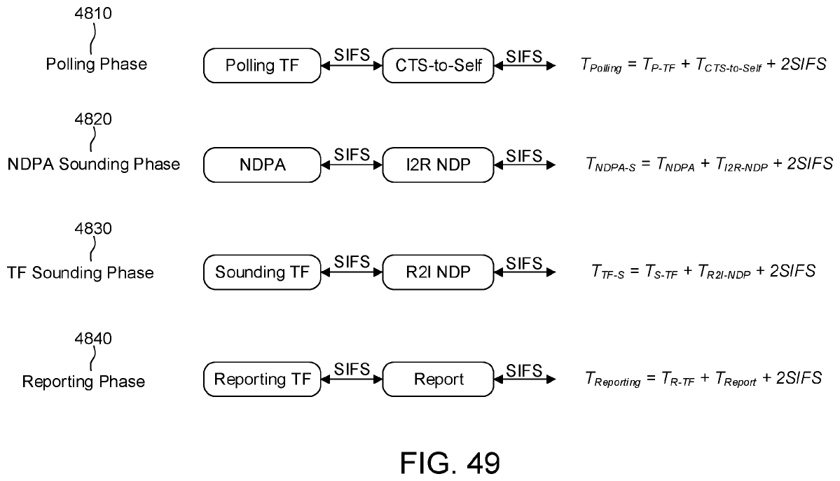

FIG. 49 illustrates timing requirements for each phase of the sensing TB measurement instance. The time required to complete each phase of the sensing TB measurement instance may be calculated different for each phase. As shown in FIG. 49, the Polling phase 4910 may include a Polling Trigger frame followed a SIFS after by a CTS-to-Self frame. The NDPA Sounding phase 4920 may include an NDPA followed a SIFS after by a I2R NDP PPDU transmitted in the downlink. The TF Sounding phase 4930 may include a Sounding Trigger frame followed a SIFS after by a R2I NDP PPDU transmitted in the uplink. The Reporting phase 4940 may include a Reporting Trigger frame followed a SIFS after by a Report frame. It is worth noting that the separation between two consecutive phases may be a SIFS.

In some embodiments, each TB sensing measurement instance may start and complete within a TXOP and shall not extend beyond the TXOP limits. In some embodiments, there may be one or more Polling phases in the same TB measurement instance, and all may come first in the TB measurement instance. The initiator that initiated the TB measurement instance may end the instance and release the channel if no responders respond back with a CTS-to-Self frame.

In some embodiments, the time required to complete one Polling phase T_{Polling} may be computed according to the formula T_{Polling}=T_{P-TF}+T_{CTS-to-Self}+2×SIFS. T_{P-TF} may be the time required to transmit the Polling Trigger frame, T_{CTS-to-self} may be the time needed to transmit the CTS-to-Self frame, and SIFS may be the Short Inter-Frame Spacing. An initiator may estimate the required time to complete one Polling phase according to a procedure that includes one or more of the steps as described in the following paragraphs.

One or more steps may include identifying the number of polled responders per one Polling phase N_{PR}.

One or more steps may include identifying the MCS that will be used by the initiator to transmit the Polling Trigger frame; identifying the Polling Trigger frame coding rate R_{P-TF}; and/or identifying the Polling Trigger frame modulation scheme (e.g., the number of bits per modulation sample N_{P-TF-bps}).
One or more steps may include identifying the MCS that will be used by the polled responders to transmit the CTS-to-Self frame; identifying the CTS-to-Self frame coding rate R_{CTSTS}; and/or identifying the Polling Trigger frame modulation scheme (the number of bits per modulation sample N_{CTSTS-bps});

One or more steps may include computing T_{P-TF} according to the formula T_{P-TF}=T_{preamble}+_{NP-TF-SYM}×T_{P-TF-SYM} where T_{preamble} is the PHY preamble duration including the duration of Signal symbol, N_{P-TF-SYM} is the number of OFDM symbols needed to carry the Polling Trigger frame and T_{P-TF-SYM} is the symbol interval of the PPDU carrying the Polling Trigger frame. One or more steps may include computing the number of OFDM symbols needed to carry the Polling Trigger frame according to the formula

$${N}_{P - TF - SYM} = ⌈ \frac{{N}_{P - TF - coded - bits}}{{N}_{P - TF - bps} {N}_{SD}} ⌉$$

where N_{P-TF-coded-bits} may be the number of coded bits of the Polling Trigger frame and N_{SD} is the number of data subcarriers. One or more steps may include computing the number of coded bits according to the formula

$${N}_{P - TF - coded - bits} = \frac{{N}_{P - TF - uncoded - bits}}{{R}_{P - TF}}$$

where N_{P-TF-uncoded-bits} may be the number of uncoded bits of the Polling Trigger frame. One or more steps may include computing the number of uncoded bits of the Polling Trigger frame according to the formula N_{P-TF-uncoded-bits}=8×(N_{mac}+N_{common}+N_{user-info} N_{PR}+N_{padding}+N_{FCS}) where N_{mac} may be the number of octets of the MAC header, N_{common} may be the number of the octets of the Common Info field of the Polling Trigger frame, N_{user-info} may be the number of the octets of the User Info field of the Polling Trigger frame, N_{padding} may be the number of the octets of the Padding field of the Polling Trigger frame and N_{FCS} may be the number of the octets of the Frame Check Sequence (FCS) field of the Polling Trigger frame.

One or more steps may include computing T_{CTS-to-self} according to the formula T_{CTS-to-self}=T_{preamble}+N_{CTSTS-SYM}×T_{CTSTS-SYM} where N_{CTSTS-SYM} may be the number of OFDM symbols needed to carry the CTS-to-Self frame and T_{CTSTS-SYM} may be the symbol interval of the PPDU carrying the CTS-to-Self frame. One or more steps may include computing the number of OFDM symbols needed to carry the CTS-to-Self frame according to the formula

$${N}_{CTSTS - SYM} = ⌈ \frac{{N}_{CTSTS - coded - bits}}{{N}_{CTSTS - bps} {N}_{SD}} ⌉$$

where N_{CTSTS-code-bits} may be the number of coded bits of the CTS-to-Self frame and N_{SD} is the number of data subcarriers. One or more steps may include computing the number of coded bits according to the formula

$${N}_{CTSTS - coded - bits} = \frac{{N}_{CTSTS - uncoded - bits}}{{R}_{CTSTS}}$$

where N_{CTSTS-uncoded-bits} may be the number of uncoded bits of the CTS-to-Self frame. One or more steps may include computing the number of uncoded bits of the CTS-to-Self frame according to the formula N_{CTSTS-uncoded-bits}=8×(N_{CTS}) where N_{CTS} may be the number of octets of the CTS frame.

In some embodiments, the time required to complete one NDPA Sounding phase T_{NDPA-S} may be computed according to the formula T_{NDPA-S}=T_{NDPA}+T_{I2R-NDP}+2×SIFS. T_{NDPA} may be the time required to transmit the NDPA frame and T_{I2R-NDP} may be the time needed to transmit the I2R NDP PPDU. An initiator may estimate the required time to complete one NDPA Sounding phase according to a procedure that includes one or more steps as described in the following paragraphs.

One or more steps may include identifying the number of responder receivers per one NDPA Sounding phase N_{RR}.

One or more steps may include identifying the MCS that will be used by the initiator to transmit the NDPA frame; identifying the NDPA frame coding rate R_{NDPA}; and/or identifying the NDPA frame modulation scheme (which may be the number of bits per modulation sample N_{NDPA-bps}).

One or more steps may include computing T_{NDPA} according to the formula T_{NDPA}=T_{preamble}+N_{NDPA-SYM}×T_{NDPA-SYM} where T_{preamble} may be the PHY preamble duration including the duration of Signal symbol, N_{NDPA-SYM} may be the number of OFDM symbols needed to carry the NDPA frame and T_{NDP-SYM} may be the symbol interval of the PPDU carrying the NDPA frame. One or more steps may include computing the number of OFDM symbols needed to carry the NDPA frame according to the formula

$${N}_{NDPA - SYM} = ⌈ \frac{{N}_{NDPA - coded - bits}}{{N}_{NDPA - bps} {N}_{SD}} ⌉$$

where N_{NDPA-coded-bits} may be the number of coded bits of the NDPA frame and N_{SD} may be the number of data subcarriers. One or more steps may include computing the number of coded bits according to the formula

$${N}_{NDPA - coded - bits} = \frac{{N}_{NDPA - uncoded - bits}}{{R}_{NDPA}}$$

where N_{NDPA-uncoded-bits} may be the number of uncoded bits of the NDPA frame. One or more steps may include computing the number of uncoded bits of the NDPA frame according to the formula N_{NDPA-uncoded-bits}=8×(N_{mac}+N_{SDT}+N_{sta-info} N_{RR}++N_{FCS}) where N_{mac} may be the number of octets of the MAC header, N_{SDT} may be the number of the octets of the Sounding Dialog Token field of the NDPA frame, N_{sta-info} may be the number of the octets of the STA Info field of the NDPA frame, and N_{FCS} may be the number of the octets of the Frame Check Sequence (FCS) field of the NDPA frame.

One or more steps may include computing T_{I2R-NDP} according to the formula

$${T}_{I 2 R - NDP} = 20 + {T}_{NDP - Preamble} + {\sum }_{n = 1}^{{N}_{RR}} {N}_{LTF - REP} ( n ) {N}_{NDP - LTF} ( n ) {T}_{NDP - LTF - SYM} + {T}_{PE} + SignalExtension$$

where T_{NDP-Preamble} may be the transmit time of the preamble of the I2R NDP PPDU, N_{LTF-REP}(n) may be the number of LTF repetitions per responder receiver, N_{NDP-LTF}(n) may be the number of LTFs per responder receiver of the I2R NDP PPDU, T_{NDP-LTF-SYM} may be the LTF symbol time of the I2R NDP PPDU, T_{PE} may be the packet extension time, and SignalExtension may be the signal extension which may depend on the spectrum.

In some embodiments, the time required to complete one TF Sounding phase T_{TF-S} may be computed according to the formula T_{TF-S}=T_{S-TF}+T_{R2I-NDP}+2×SIFS. T_{S-TF} may be the time required to transmit the Sounding Trigger frame and T_{R2I-NDP} may be the time needed to transmit the R2I NDP PPDU. The initiator may estimate the required time to complete one TF Sounding phase according to a procedure that includes one or more steps as described in the following paragraphs.

One or more steps may include identifying the number of responder transmitters per one TF Sounding phase N_{RT}.

One or more steps may include identifying the MCS that will be used by the initiator to transmit the Sounding Trigger frame; identifying the Sounding Trigger frame coding rate R_{S-TF}; and/or identifying the Sounding Trigger frame modulation scheme (the number of bits per modulation sample N_{S-TF-bps}).

One or more steps may include computing T_{S-TF} according to the formula T_{S-TF}=T_{preamble}+N_{S-TF-SYM}×T_{S-TF-SYM} where T_{preamble} may be the PHY preamble duration including the duration of Signal symbol, N_{S-TF-SYM} may be the number of OFDM symbols needed to carry the Sounding Trigger frame and T_{S-TF-SYM} may be the symbol interval of the PPDU carrying the Sounding Trigger frame. One or more steps may include computing the number of OFDM symbols needed to carry the Sounding Trigger frame according to the formula

$${N}_{S - TF - SYM} = ⌈ \frac{{N}_{S - TF - coded - bits}}{{N}_{S - TF - bps} {N}_{SD}} ⌉$$

where N_{S-TF-coded-bits} may be the number of coded bits of the Sounding Trigger frame and N_{SD} may be the number of data subcarriers. One or more steps may include computing the number of coded bits according to the formula

$${N}_{S - TF - coded - bits} = \frac{{N}_{S - TF - uncoded - bits}}{{R}_{S - TF}}$$

where N_{S-TF-uncoded-bits} may be the number of uncoded bits of the Sounding Trigger frame. One or more steps may include computing the number of uncoded bits of the Sounding Trigger frame according to the formula N_{S-TF-uncoded-bits}=8×(N_{mac}+N_{common}+N_{user-info} N_{RT}+N_{padding}+N_{FCS}) where N_{mac} may be the number of octets of the MAC header, N_{common} may be the number of the octets of the Common Info field of the Sounding Trigger frame, N_{user-info} may be the number of the octets of the User Info field of the Sounding Trigger frame, N_{padding} may be the number of the octets of the Padding field of the Sounding Trigger frame, and N_{FCS} may be the number of the octets of the Frame Check Sequence (FCS) field of the Sounding Trigger frame.

One or more steps may include computing T_{R2I-NDP} according to the formula

$${T}_{R 2 I - NDP} = 20 + {T}_{NDP - Preamble} + {\sum }_{n = 1}^{{N}_{RT}} {N}_{LTF - REP} ( n ) {N}_{NDP - LTF} ( n ) {T}_{NDP - LTF - SYM} + {T}_{PE} + SignalExtension$$

where T_{NDP-Preamble} is the transmit time of the preamble of the I2R NDP PPDU, N_{LTF-REP}(n) is the number of LTF repetitions per responder transmitter N_{NDP-LTF}(n) is the number of LTFs per responder transmitter of the R2I NDP PPDU, T_{NDP-LTF-SYM} is the LTF symbol time of the R2I NDP PPDU, T_{PE} is the packet extension time and SignalExtension is the signal extension which depends on the spectrum.

In some embodiments, the time required to complete one Reporting phase T_{TF-R} may be computed according to the formula T_{TF-R}=T_{R-TF}+T_{Report}+2×SIFS, where T_{S-TF} may be the time required to transmit the Reporting Trigger frame and T_{Report} may be the time needed to transmit the Report frame. The initiator may estimate the required time to complete one Reporting phase according to a procedure that includes one or more steps as described in the following paragraphs.

One or more steps may include identifying the number of responders triggered to send their measurement feedback reports per one Reporting phase N_{RF}.

One or more steps may include identifying the MCS that will be used by the initiator to transmit the Reporting Trigger frame; identifying the Reporting Trigger frame coding rate R_{R-TF}; and/or identifying the Reporting Trigger frame modulation scheme (the number of bits per modulation sample N_{R-TF-bps}).

One or more steps may include identifying the MCS that will be used by the responders to transmit the Report frame; identifying the Report frame coding rate R_{FR}; and/or identifying the Report frame modulation scheme (the number of bits per modulation sample N_{FR-bps}).

One or more steps may include computing T_{R-TF} according to the formula T_{R-TF}=T_{preamble}+N_{R-TF-SYM}×T_{R-TF-SYM}, where T_{preamble} may be the PHY preamble duration including the duration of Signal symbol, N_{R-TF-SYM} may be the number of OFDM symbols needed to carry the Reporting Trigger frame and T_{R-TF-SYM} may be the symbol interval of the PPDU carrying the Reporting Trigger frame. One or more steps may include computing the number of OFDM symbols needed to carry the Reporting Trigger frame according to the formula

$${N}_{R - TF - SYM} = ⌈ \frac{{N}_{R - TF - coded - bits}}{{N}_{R - TF - bps} {N}_{SD}} ⌉ ,$$

where N_{RT-coded-bits} may be the number of coded bits of the Reporting Trigger frame and N_{SD} may be the number of data subcarriers. One or more steps may include computing the number of coded bits according to the formula

$${N}_{R - TF - coded - bits} = \frac{{N}_{R - TF - uncoded - bits}}{{R}_{R - TF}}$$

where N_{R-TF-uncoded-bits} may be the number of uncoded bits of the Reporting Trigger frame. One or more steps may include computing the number of uncoded bits of the Reporting Trigger frame according to the formula N_{R-TF-uncoded-bits}=8×(N_{mac}+N_{common}+N_{user-info} N_{RF}+N_{padding}+N_{FCS}) where N_{mac} may be the number of octets of the MAC header, N_{common} may be the number of the octets of the Common Info field of the Reporting Trigger frame, N_{user-info} may be the number of the octets of the User Info field of the Reporting Trigger frame, N_{padding} may be the number of the octets of the Padding field of the Reporting Trigger frame and N_{FCS} may be the number of the octets of the Frame Check Sequence (FCS) field of the Reporting Trigger frame.

One or more steps may include computing T_{Report} according to the formula T_{Report}=T_{preamble}+N_{Report-SYM}×T_{Report-SYM} Where T_{preamble} may be the TB-PPDU PHY preamble duration, N_{Report-SYM} may be the number of OFDM symbols needed to carry the Reporting frame and T_{Report-SYM} is the symbol interval of the TB-PPDU carrying the Reporting frame. One or more steps may include computing the number of OFDM symbols needed to carry the Report frame according to the formula

$${N}_{Report - SYM} = ⌈ \frac{{N}_{Report - coded - bits}}{{N}_{Report - bps} {N}_{SD}} ⌉$$

where N_{Report-coded-bits} may be the number of coded bits of the Report frame and N_{SD} may be the number of data subcarriers One or more steps may include may include computing the number of coded bits according to the formula

$${N}_{Report - coded - bits} = \frac{{N}_{Report - uncoded - bits}}{{R}_{FR}}$$

where N_{Report-uncoded-bits} may be the number of uncoded bits of the Report frame. One or more steps may include computing the number of uncoded bits of the Report frame according to the formula

$${N}_{Report - uncoded - bits} = 8 \times ( {N}_{mac} + {N}_{report - control} + {\sum }_{r = 1}^{{N}_{reports}} {N}_{ReportField} ( r ) + {N}_{padding} + {N}_{FCS} )$$

where N_{mac} may be the number of octets of the MAC header, N_{report-control} may be the number of the octets of the Report Control field of the Report frame, Nᵣₑₚₒᵣₜₛ may be the number of aggregated reports in the Report frame, N_{ReportField} (r) may be the number of octets of the report r, N_{padding} may be the number of the octets of the Padding field of the Report frame, and N_{FCS} may be the number of the octets of the Frame Check Sequence (FCS) field of the Report frame.

In some embodiments, the initiator may estimate the maximum number of responder transmitter(s) that can participate in the TF Sounding phase(s) of a TB sensing measurement instance given the duration of the sensing TXOP according and the total number of polled responders N_{responders} according to a procedure that includes one or more steps as described in the following paragraphs.

One or more steps may include identifying which phases will be in the considered TB sensing measurement instance; computing the time needed for one Polling phase T_{polling}; and/or computing the required number of Polling phases to poll all the responders N_{responders} according to the formula

$${N}_{p} = ⌈ \frac{{N}_{responders}}{{N}_{PR}} ⌉ .$$

One or more steps may include computing the time required to perform the NDPA Sounding phases T_{NDPA-total}=N_{NDPA}×T_{NDPA-S} where N_{NDPA} may be the number of NDPA phases in the TB sensing measurement instance. This parameter may be implementation specific.

One or more steps may include computing the time required to perform the Reporting phases T_{Reporting-total}=N_{Reporting}×T_{Reporting} where N_{Reporting} may be the number of Reporting phases in the TB sensing measurement instance. This parameter may be implementation specific.

Based on the considered phases in the TB sensing measurement instance, the maximum number of responder transmitters that can participate in the TF Sounding phases may be computed as

$${N}_{RT , total}^{max} = {N}_{RT} \times ⌊ \frac{( TXOP - {\sum }_{m = 1}^{M} {T}_{phase} ( m ) )}{{T}_{TF - S}} ⌋$$

where TXOP may be the TXOP duration, Tₚₕₐₛₑ(m) may be the time required to perform the phase m and M may be the total number of all phases considered in the TB sensing measurement instance.

Although the features and elements of the present invention are described in the preferred embodiments in particular combinations, each feature or element can be used alone without the other features and elements of the preferred embodiments or in various combinations with or without other features and elements of the present invention. Although the solutions described herein consider 802.11 specific protocols, it is understood that the solutions described herein are not restricted to this scenario and are applicable to other wireless systems as well. Although the term SIFS may be used to indicate various inter frame spacing in the examples of the designs and procedures, other inter frame spacing such as RIFS, AIFS, DIFS or other agreed time interval could be used interchangeably in the same solutions. Although four RBs per triggered TXOP may be shown in some figures as examples, the actual number of RBs/channels/bandwidth utilized may vary. Although specific bits may be used to signal in-BSS/OBSS statuses by way of example, other bits may be used to signal this information. Although some Trigger Type values or terms may be used as examples to identify newly defined trigger frame variants, other values or terms may be used. The terms Multi-AP and MAP may be used interchangeably to refer to the same concept. A Long Training Field (LTF) may be any type of predefined sequence that is known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A sensing responder comprising:
a processor and a transceiver configured to receive, from a sensing initiator, a sensing measurement setup request frame initiating a wireless local area network (WLAN) sensing setup procedure associated with a sensing measurement instance;
the processor and the transceiver configured to transmit a sensing measurement setup response frame to the sensing initiator; and
the processor and the transceiver configured to receive, from the sensing initiator, a sensing measurement setup termination frame, the sensing measurement setup termination frame including an indication to terminate the WLAN sensing setup procedure associated with the sensing measurement instance and at least one other WLAN sensing setup procedure associated with at least one other sensing measurement instance, the sensing measurement setup termination frame including a sensing measurement identifier (ID) associated with the sensing measurement instance and at least one sensing measurement ID associated with the at least one other sensing measurement instance.

22. The sensing responder of claim 21, the processor configured to, in response to the received sensing measurement setup termination frame, release resources allocated for the sensing measurement instance.

23. The sensing responder of claim 21, the processor and the transceiver configured to send an acknowledgment to the sensing initiator in response to the received sensing measurement termination frame.

24. The sensing responder of claim 21, the processor and the transceiver configured to send a sensing measurement setup termination response frame to the sensing initiator in response to the received sensing measurement setup termination frame.

25. The sensing responder of claim 21, wherein the sensing measurement setup termination frame include a plurality of subfields respectively associated with the sensing measurement instance and the at least one other sensing measurement instance.

26. The sensing responder of claim 21, wherein the sensing measurement setup response frame includes information indicating rejection in response to the sensing measurement setup request frame.

27. The sensing responder of claim 21, wherein the sensing responder is a non-access point (non-AP) station (STA).

28. A method performed by a sensing responder, the method comprising:
receiving, from a sensing initiator, a sensing measurement setup request frame initiating a wireless local area network (WLAN) sensing setup procedure associated with a sensing measurement instance;
transmitting a sensing measurement setup response frame to the sensing initiator; and
receiving, from the sensing initiator, a sensing measurement setup termination frame, the sensing measurement setup termination frame including an indication to terminate the WLAN sensing setup procedure associated with the sensing measurement instance and at least one other WLAN sensing setup procedure associated with at least one other sensing measurement instance, the sensing measurement setup termination frame including a sensing measurement identifier (ID) associated with the sensing measurement instance and at least one sensing measurement ID associated with the at least one other sensing measurement instance.

29. The method of claim 28 comprising releasing, in response to the received sensing measurement setup termination frame, resources allocated for the sensing measurement instance.

30. The method of claim 28 comprising sending an acknowledgment to the sensing initiator in response to the received sensing measurement termination frame.

31. The method of claim 28 comprising sending a sensing measurement setup termination response frame to the sensing initiator in response to the received sensing measurement setup termination frame.

32. The method of claim 28 comprising, wherein the sensing measurement setup termination frame include a plurality of subfields respectively associated with the sensing measurement instance and the at least one other sensing measurement instance.

33. The method of claim 28 comprising, wherein the sensing measurement setup response frame includes information indicating rejection in response to the sensing measurement setup request frame.

34. The method of claim 28 comprising, wherein the sensing responder is a non-access point (non-AP) station (STA).

35. A sensing initiator comprising:
a processor and a transceiver configured to send, to a plurality of sensing responders, a respective plurality of sensing measurement setup request frames initiating wireless local area network (WLAN) sensing setup procedures associated with a respective plurality of sensing measurement instance;
the processor and the transceiver configured to receive at least one sensing measurement setup response frame from at least one of the plurality of sensing responders; and
the processor and the transceiver configured to transmit, plurality of sensing responders, a sensing measurement setup termination frame, the sensing measurement setup termination frame including an indication to terminate the respective plurality of WLAN sensing setup procedures associated with the respective plurality of sensing measurement instances, the sensing measurement setup termination frame including a plurality of sensing measurement identifiers (IDs) associated with the plurality of sensing measurement instances.

36. The sensing initiator of claim 35, the processor configured to, subsequent to the transmission of the sensing measurement setup termination frame, release resources allocated for one or more of the plurality of sensing measurement instances.

37. The sensing initiator of claim 36, wherein the at least one sensing measurement setup response frame is an acknowledgement message.

38. The sensing initiator of claim 36, the processor and the transceiver configured to receive a sensing measurement setup termination response frame in response to the sensing measurement setup termination frame.

39. The sensing initiator of claim 36, wherein the at least one sensing measurement setup response frame includes information indicating rejection in response to the sensing measurement setup request.

40. The sensing initiator of claim 36, wherein the sensing responder is an access point (AP) station (STA).
